(19) United States
(12) Patent Application Publication
(10) Pub. No.: US 2025/0353785 A1
(43) Pub. Date: Nov. 20, 2025

(54) METHODS FOR TREATING GLASS CERAMIC ARTICLES AND TREATED GLASS CERAMIC ARTICLES

(71) Applicant: CORNING INCORPORATED, CORNING, NY (US)

(72) Inventors: Jaymin Amin, Corning, NY (US); Timothy Evan Dimond, Corning, NY (US); Albert Joseph Fahey, Corning, NY (US); Mathieu Gerard Jacques Hubert, Corning, NY (US); Yuhui Jin, Painted Post, NY (US); Christine Marie Mahoney Fahey, Corning, NY (US); Pascale Oram, Painted Post, NY (US); Sarah Elizabeth Roberts, Painted Post, NY (US); Sarah Marie Waterfield, Horseheads, NY (US)

(21) Appl. No.: 19/207,819

(22) Filed: May 14, 2025

Related U.S. Application Data
(60) Provisional application No. 63/647,706, filed on May 15, 2024.

(51) Int. Cl. C03C 21/00; C03C 10/00

(52) U.S. Cl. CPC C03C 21/002; C03C 10/0054

(57) ABSTRACT

Disclosed herein are methods of treating glass ceramic articles including contacting at least a portion of a glass ceramic article with a first salt bath to form an ion-exchanged glass ceramic article and removing a portion of the ion-exchanged glass ceramic article to a depth greater than or equal to 2 μm and less than or equal to 10 μm from a first major surface of the ion-exchanged glass ceramic article to form a post-IOX polished glass ceramic article. The first salt bath includes greater than or equal to 20 wt. % and less than or equal to 90 wt. % KNO₃, greater than or equal to 10 wt. % and less than or equal to 80 wt. % NaNO₃, greater than or equal to 0.03 wt. % and less than or equal to 0.3 wt. % LiNO₃, and greater than or equal to 0.2 wt. % and less than or equal to 1 wt. % silicic acid.

### CROSS-REFERENCE TO RELATED APPLICATIONS

The present application claims the benefit of U.S. Provisional Patent Application Ser. No. 63/647,706 filed May 15, 2024 and entitled “Methods for Treating Glass Ceramic Articles and Treated Glass Ceramic Articles,” the entirety of which is incorporated herein by reference.

### FIELD

The present specification generally relates to methods for treating glass ceramic articles and, in particular, to methods of treating glass ceramic articles by ion-exchange, post-ion exchange polishing, and coating.

### TECHNICAL BACKGROUND

Transparent glass ceramic articles may be used as cover materials for displays and cameras of consumer electronic devices. Light may pass through a glass ceramic article used to cover a display or camera with minimal scattering to transmit or capture images with high fidelity. However, during the lifecycle of a consumer electronic device, light scattering features may form on the surface of conventional glass ceramic articles, due to the migration of alkali species to the surface of the glass ceramic article. The alkali species that migrate to the surface of the glass ceramic article may form alkali hydroxides. The alkali hydroxides, which are hydrophilic, may separate in the presence of a hydrophobic surface contaminant (e.g., siloxanes from adhesives), thereby forming light scattering features or surface blemishes on the surface that may scatter light and reduce the fidelity of images displayed or captured through the glass ceramic article.

Therefore, a continuing need exists for methods of treating glass ceramic articles to reduce the migration of alkali species to the surface of the glass ceramic articles to reduce the formation of light scattering features.

### SUMMARY

Aspect 1. A method of treating a glass ceramic article, the method comprising, contacting at least a portion of the glass ceramic article with a first salt bath to form an ion-exchanged glass ceramic article, and removing a portion of the ion-exchanged glass ceramic article to a depth greater than or equal to 1 μm and less than or equal to 10 μm from a first major surface of the ion-exchanged glass ceramic article to form a post-IOX polished glass ceramic article. The first salt bath comprises greater than or equal to 20 wt. % and less than or equal to 90 wt. % KNO₃, greater than or equal to 10 wt. % and less than or equal to 80 wt. % NaNO₃, greater than or equal to 0.03 wt. % and less than or equal to 0.3 wt. % LiNO₃, and greater than or equal to 0.2 wt. % and less than or equal to 1 wt. % silicic acid.

Aspect 2. The method of aspect 1, wherein the contacting the at least a portion of the glass ceramic article with the first salt bath occurs for a first time period greater than or equal to 7 minutes and less than or equal to 210 minutes.

Aspect 3. The method of aspect 1 or aspect 2, wherein the contacting the at least a portion of the glass ceramic article with the first salt bath occurs at a first temperature greater than or equal to 450° C. and less than or equal to 550° C.

Aspect 4. The method of any one of aspects 1 to 3, further comprising removing a portion of the ion-exchanged glass ceramic article to a depth greater than or equal to 1 μm and less than or equal to 10 μm from a second major surface of the ion-exchanged glass ceramic article.

Aspect 5. The method of any one of aspects 1 to 4, wherein a weight ratio of lithium to sodium in the first salt bath is greater than or equal to 3.8×10⁻⁴ and less than or equal to 7.5×10⁻³.

Aspect 6. The method of any one of aspects 1 to 5, further comprising contacting the glass ceramic article with a second salt bath, after contacting the glass ceramic article with the first salt bath, to form the ion-exchanged glass ceramic article, wherein the second salt bath comprises: greater than or equal to 95 wt. % and less than or equal to 100 wt. % KNO₃, greater than or equal to 0 wt. % and less than or equal to 5 wt. % NaNO₃, and greater than 0.2 wt. % and less than or equal to 1 wt. % silicic acid.

Aspect 7. The method of aspect 6, wherein the contacting glass ceramic article with the second salt bath occurs for a second time period greater than or equal to 15 minutes and less than or equal to 30 minutes.

Aspect 8. The method of aspect 6 or aspect 7, wherein the contacting the glass ceramic article with the second salt bath occurs at a second temperature greater than or equal to 450° C. and less than or equal to 550° C.

Aspect 9. The method of any one of aspects 1 to 8, wherein the portion of the ion-exchanged glass ceramic article is removed by chemical mechanical polishing.

Aspect 10. The method of any one of aspects 1 to 9, wherein the portion of the ion-exchanged glass ceramic article is removed by chemical etching.

Aspect 11. The method of aspect 10, wherein the chemical etching comprises contacting the ion-exchanged glass ceramic article with an etchant comprising one or more hydroxides.

Aspect 12. The method of aspect 10, wherein the chemical etching comprises contacting the ion-exchanged glass ceramic article with an etchant comprising hydrofluoric acid.

Aspect 13. The method of any one of aspects 1 to 12, wherein the glass ceramic article comprises: greater than or equal to 55 mol % and less than or equal to 75 mol % SiO₂; greater than or equal to 0.2 mol % and less than or equal to 10 mol % Al₂O₃; greater than or equal to 0 mol % and less than or equal to 5 mol % B₂O₃; greater than or equal to 15 mol % and less than or equal to 30 mol % Li₂O; greater than or equal to 0 mol % and less than or equal to 2 mol % Na₂O; greater than or equal to 0 mol % and less than or equal to 2 mol % K₂O; greater than or equal to 0 mol % and less than or equal to 2 mol % MgO; greater than or equal to 0 mol % and less than or equal to 2 mol % ZnO; greater than or equal to 0.2 mol % and less than or equal to 3 mol % P₂O₅; greater than or equal to 0.1 mol % and less than or equal to 10 mol % ZrO₂; greater than or equal to 0 mol % and less than or equal to 4 mol % TiO₂; greater than or equal to 0 mol % and less than or equal to 1 mol % SnO₂; and greater than or equal to 0 mol % and less than or equal to 2 mol % Y₂O₃.

Aspect 14. The method of any one of aspects 1 to 13, wherein the post-IOX polished glass ceramic article comprises potassium at a depth of greater than or equal to 1 μm to less than or equal to 10 μm from the first major surface.

Aspect 15. The method of any one of aspects 1 to 14, wherein a concentration of potassium at a depth greater than or equal to 1 μm and less than or equal to 10 μm from the first major surface of the post-IOX polished glass ceramic article is greater than or equal to 1 mol % and less than or equal to 1.5 mol %.

Aspect 16. The method of any one of aspects 1 to 5, wherein the post-IOX polished glass ceramic article comprises a single guided mode in the prism coupling spectrum at a wavelength between 360 nm and 405 nm for at least one of a transverse-magnetic or transverse-electric polarization.

Aspect 17. The method of any one of aspects 1 to 16, wherein a concentration of Li₂O, a concentration of Na₂O, and a concentration of K₂O are within 5 mol % of each other at a depth greater than or equal to 2 nm and less than or equal to 3 μm from the first major surface of the post-IOX polished glass ceramic article.

Aspect 18. The method of aspect 17, wherein the concentration of Li₂O is greater than the concentration of Na₂O at a depth greater than or equal to 2 nm and less than or equal to 3 μm from the first major surface of the post-IOX polished glass ceramic article.

Aspect 19. The method of any one of aspects 1 to 18, wherein a depth of compression of the post-IOX polished glass ceramic article is less than or equal to 120 μm.

Aspect 20. The method of any one of aspects 1 to 19, wherein a compressive stress of the post-IOX polished glass ceramic article is greater than or equal to 150 MPa and less than or equal to 450 MPa.

Aspect 21. The method of any one of aspects 1 to 20, wherein a maximum central tension of the post-IOX polished glass ceramic article is greater than or equal to 35 MPa and less than or equal to 200 MPa.

Aspect 22. A method of treating a glass ceramic article, the method comprising, contacting at least a portion of a glass ceramic article with a salt bath for a time period greater than or equal to 90 minutes and less than or equal to 165 minutes at a temperature greater than or equal to 470° C. and less than or equal to 500° C. to form an ion-exchanged glass ceramic article, and removing a portion of the ion-exchanged glass ceramic article to a depth greater than or equal to 2 μm and less than or equal to 3 μm from a first major surface of the first ion-exchanged glass ceramic article to form a post-IOX polished glass ceramic article. The salt bath comprises greater than or equal to 70 wt. % and less than or equal to 85 wt. % KNO₃, greater than or equal to 15 wt. % and less than or equal to 30 wt. % NaNO₃, greater than or equal to 0.1 wt. % and less than or equal to 0.15 wt. % LiNO₃, and greater than or equal to 0.2 wt. % and less than or equal to 1 wt. % silicic acid.

Aspect 23. The method of aspect 22 wherein a concentration of potassium at a depth greater than or equal to 1 μm and less than or equal to 10 μm from the first major surface of the polished glass ceramic article is greater than or equal to 1 mol % and less than or equal to 1.5 mol %; a concentration of Li₂O, a concentration of Na₂O, and a concentration of K₂O are within 5 mol % of each other at a depth greater than or equal to 2 nm and less than or equal to 3 μm from the first major surface of the post-IOX polished glass ceramic article; and the concentration of Li₂O is greater than the concentration of Na₂O at a depth greater than or equal to 2 nm and less than or equal to 3 μm from the first major surface of the post-IOX polished glass ceramic article.

Aspect 24. The method of aspect 22 or aspect 23 a depth of compression of the post-IOX polished glass ceramic article is less than or equal to 120 μm; a compressive stress of the post-IOX polished glass ceramic article is greater than or equal to 150 MPa and less than or equal to 450 MPa; and a maximum central tension of the post-IOX polished glass ceramic article is greater than or equal to 35 MPa and less than or equal to 200 MPa.

Aspect 25. A method of treating a glass ceramic article, the method comprising contacting at least a portion of a glass ceramic article with a first salt bath for a first time period greater than or equal to 95 minutes and less than or equal to 115 minutes at a first temperature greater than or equal to 470° C. and less than or equal to 500° C. to form a first ion-exchanged glass ceramic article, contacting the first ion-exchanged glass ceramic article with a second salt bath for a second time period greater than or equal to 10 minutes and less than or equal to 20 minutes and at a second temperature greater than or equal to 470° C. and less than or equal to 500° C. to form a second ion-exchanged glass ceramic article, and removing a portion of the second ion-exchanged glass ceramic article to a depth greater than or equal to 2 μm and less than or equal to 3 μm from a first major surface of the second ion-exchanged glass ceramic article to form a post-IOX polished glass ceramic article. The first salt bath comprises greater than or equal to 80 wt. % and less than or equal to 85 wt. % KNO₃, greater than or equal to 15 wt. % and less than or equal to 20 wt. % NaNO₃, greater than or equal to 0.1 wt. % and less than or equal to 0.3 wt. % LiNO₃, and greater than or equal to 0.2 wt. % and less than or equal to 1 wt. % silicic acid. The second salt bath comprises greater than or equal to 95 wt. % and less than or equal to 100 wt. % KNO₃ and greater than or equal to 0.2 wt. % and less than or equal to 1 wt. % silicic acid.

Aspect 26. The method of aspect 25, wherein a concentration of potassium at a depth greater than or equal to 1 μm and less than or equal to 10 μm from the first major surface of the post-IOX polished glass ceramic article is greater than or equal to 1 mol % and less than or equal to 1.5 mol %; a concentration of Li₂O, a concentration of Na₂O, and a concentration of K₂O are within 5 mol % of each other at a depth greater than or equal to 2 nm and less than or equal to 3 μm from the first major surface of the post-IOX polished glass ceramic article; and the concentration of Li₂O is greater than the concentration of Na₂O at a depth greater than or equal to 2 nm and less than or equal to 3 μm from the first major surface of the post-IOX polished glass ceramic article.

Aspect 27. The method of aspect 25 or aspect 26, wherein a depth of compression of the post-IOX polished glass ceramic article is less than or equal to 120 μm; a compressive stress of the post-IOX polished glass ceramic article is greater than or equal to 150 MPa and less than or equal to 450 MPa; and a maximum central tension of the post-IOX polished glass ceramic article is greater than or equal to 35 MPa and less than or equal to 200 MPa.

Aspect 28. A post-IOX polished glass ceramic article comprising a first major surface and a second major surface opposite the first major surface, wherein the first major surface of the post-IOX polished glass ceramic article is at least partially coated with a hydrophobic contaminant, and the first major surface of the post-IOX polished glass ceramic article is substantially free from light scattering features after exposing the post-IOX polished glass ceramic article to a temperature greater than or equal to 55° C. and less than or equal to 85° C. at a relative humidity greater than or equal to 85% and less than or equal to 95% for a time of 72 hours, wherein the presence of light scattering features is evaluated by an image analysis of a portion of the first major surface of the post-IOX polished glass ceramic article.

Aspect 29. The post-IOX polished glass ceramic article of aspect 28, wherein the hydrophobic contaminant comprises polydimethylsiloxane (PDMS).

Aspect 30. The post-IOX polished glass ceramic article of aspect 28 or aspect 29, wherein the light scattering features comprise one or more alkali hydroxides.

Aspect 31. The post-IOX polished glass ceramic article of any one of claims 28 to 30, wherein a concentration of potassium at a depth greater than or equal to 1 μm and less than or equal to 10 μm from the first major surface of the post-IOX polished glass ceramic article is greater than or equal to 1 mol % and less than or equal to 1.5 mol %.

Aspect 32. The post-IOX polished glass ceramic article of any one of aspects 28 to 31, wherein a concentration of Li₂O, a concentration of Na₂O, and a concentration of K₂O are within 5 mol % of each other at a depth greater than or equal to 2 nm and less than or equal to 3 μm from the first major surface of the post-IOX polished glass ceramic article.

Aspect 33. The post-IOX polished glass ceramic article of any one of aspects 28 to 32, wherein a depth of compression of the post-IOX polished glass ceramic article is less than or equal to 120 μm.

Aspect 34. The post-IOX polished glass ceramic article of any one of aspects 28 to 33, wherein a compressive stress of the post-IOX polished glass ceramic article is greater than or equal to 150 MPa and less than or equal to 450 MPa.

Aspect 35. The post-IOX polished glass ceramic article of any one of aspects 28 to 34, wherein a maximum central tension of the post-IOX polished glass ceramic article is greater than or equal to 35 MPa and less than or equal to 200 MPa.

Aspect 36. The post-IOX polished glass ceramic article of any one of aspects 28 to 35, wherein the concentration of Li₂O is greater than the concentration of Na₂O at a depth greater than or equal to 2 nm and less than or equal to 3 μm from the first major surface of the post-IOX polished glass ceramic article.

Aspect 37. The post-IOX polished glass ceramic article of any one of claims 28 to 36, wherein the post-IOX polished glass ceramic article comprises: greater than or equal to 55 mol % and less than or equal to 75 mol % SiO₂; greater than or equal to 0.2 mol % and less than or equal to 10 mol % Al₂O₃; greater than or equal to 0 mol % and less than or equal to 5 mol % B₂O₃; greater than or equal to 15 mol % and less than or equal to 30 mol % Li₂O; greater than or equal to 0 mol % and less than or equal to 2 mol % Na₂O; greater than or equal to 0 mol % and less than or equal to 2 mol % K₂O; greater than or equal to 0 mol % and less than or equal to 2 mol % MgO; greater than or equal to 0 mol % and less than or equal to 2 mol % ZnO; greater than or equal to 0.2 mol % and less than or equal to 3 mol % P₂O₅; greater than or equal to 0.1 mol % and less than or equal to 10 mol % ZrO₂; greater than or equal to 0 mol % and less than or equal to 4 mol % TiO₂; greater than or equal to 0 mol % and less than or equal to 1 mol % SnO₂; and greater than or equal to 0 mol % and less than or equal to 2 mol % Y₂O₃.

Aspect 38. A coated glass ceramic article comprising: a glass ceramic substrate comprising a first major surface and a second major surface opposite the first major surface; and a coating covering at least a portion of the first major surface of the glass ceramic substrate, wherein the coating comprises a material having substantially the same index of refraction as the glass ceramic substrate. An outer surface of the coating is at least partially coated with a hydrophobic contaminant and the outer surface of the coating is substantially free from light scattering features after exposing the coated glass ceramic article to a temperature greater than or equal to 55° C. and less than or equal to 85° C. at a relative humidity greater than or equal to 85% and less than or equal to 95% for a time of 72 hours, wherein the presence of light scattering features is evaluated by an image analysis of a portion of the outer surface of the coating.

Aspect 39. The coated glass ceramic article of aspect 38, wherein the hydrophobic contaminant comprises polydimethylsiloxane (PDMS).

Aspect 40. The coated glass ceramic article of aspect 38 or aspect 39, wherein the coating comprises a single layer.

Aspect 41. The coated glass ceramic article of any one of aspects 38 to 40, wherein the coating comprises silicon dioxide.

Aspect 42. The coated glass ceramic article of any one of aspects 38 to 41, wherein the coating comprises a plurality of layers.

Aspect 43. The coated glass ceramic article of any one of aspects 38 to 42, wherein a root mean square roughness Rq of the first major surface of the glass ceramic substrate is less than or equal to 1 nm.

Aspect 44. The coated glass ceramic article of any one of aspects 38 to 43, wherein the coating has a thickness greater than or equal to 10 nm and less than or equal to 100 nm.

Aspect 45. The coated glass ceramic article of any one of aspects 38 to 44, wherein the glass ceramic substrate comprises: greater than or equal to 55 mol % and less than or equal to 75 mol % SiO₂; greater than or equal to 0.2 mol % and less than or equal to 10 mol % Al₂O₃; greater than or equal to 0 mol % and less than or equal to 5 mol % B₂O₃; greater than or equal to 15 mol % and less than or equal to 30 mol % Li₂O; greater than or equal to 0 mol % and less than or equal to 2 mol % Na₂O; greater than or equal to 0 mol % and less than or equal to 2 mol % K₂O; greater than or equal to 0 mol % and less than or equal to 2 mol % MgO; greater than or equal to 0 mol % and less than or equal to 2 mol % ZnO; greater than or equal to 0.2 mol % and less than or equal to 3 mol % P₂O₅; greater than or equal to 0.1 mol % and less than or equal to 10 mol % ZrO₂; greater than or equal to 0 mol % and less than or equal to 4 mol % TiO₂; greater than or equal to 0 mol % and less than or equal to 1 mol % SnO₂; and greater than or equal to 0 mol % and less than or equal to 2 mol % Y₂O₃.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic view of a glass ceramic article coated with a hydrophobic contaminant, according to one or more embodiments described herein;

FIG. 2 is a plan view of an electronic device incorporating any of the glass ceramic articles according to one or more embodiments described herein;

FIG. 3 is a perspective view of the electronic device of FIG. 2;

FIG. 4A is a mass-selected Time-of-Flight Secondary Ion Mass Spectrometry (ToF-SIMS) image of a surface of an aged glass ceramic article;

FIG. 4B is a mass-selected ToF-SIMS image of a surface of an aged glass ceramic article;

FIG. 5A is a differential interference contrast (DIC) optical micrograph of a surface of an aged glass ceramic article;

FIG. 5B is a DIC optical micrograph of a surface of an aged glass ceramic article;

FIG. 5C is a DIC optical micrograph of a surface of an aged glass ceramic article;

FIG. 6A is a mass-selected ToF-SIMS image of a surface of an aged comparative glass ceramic article;

FIG. 6B is a mass-selected ToF-SIMS image of a surface of an aged comparative glass ceramic article;

FIG. 7 is a DIC optical micrograph of a surface of an aged comparative glass ceramic article;

FIG. 8 is a ToF-SIMS depth profile of a coated glass ceramic article;

FIG. 9A is an atomic force microscopy (AFM) image of a surface of a glass ceramic article;

FIG. 9B is an AFM image of a surface of a glass ceramic article; and

FIG. 10 depicts CIELAB (Commission international de l'éclairage) color space data from coated and uncoated glass ceramic articles.

### DETAILED DESCRIPTION

Reference will now be made in detail to various embodiments of methods of treating glass ceramic articles and treated glass ceramic articles that mitigate the formation of light scattering features.

According to embodiments, methods of treating glass ceramic articles may comprise contacting at least a portion of a glass ceramic article with a first bath to form an ion-exchanged glass ceramic article and removing a portion of the ion-exchanged glass ceramic article to a depth greater than or equal to 2 μm and less than or equal to 10 μm from a first major surface of the ion-exchanged glass ceramic article to form a post-IOX polished glass ceramic article. The first salt bath comprises greater than or equal to 20 wt. % and less than or equal to 90 wt. % KNO₃, greater than or equal to 10 wt. % and less than or equal to 80 wt. % NaNO₃, greater than or equal to 0.03 wt. % and less than or equal to 0.3 wt. % LiNO₃, and greater than or equal to 0.2 wt. % and less than or equal to 1 wt. % silicic acid.

According to embodiments, methods of treating glass ceramic articles may comprise contacting at least a portion of a glass ceramic article with a salt bath for a time period greater than or equal to 90 minutes and less than or equal to 165 minutes at a temperature greater than or equal to 470° C. and less than or equal to 500° C. to form an ion-exchanged glass ceramic article. The salt bath may comprise greater than or equal to 70 wt. % and less than or equal to 85 wt. % KNO₃, greater than or equal to 15 wt. % and less than or equal to 30 wt. % NaNO₃, greater than or equal to 0.1 wt. % and less than or equal to 0.15 wt. % LiNO₃, and greater than or equal to 0.2 wt. % and less than or equal to 1 wt. % silicic acid. The method may further comprise removing a portion of the ion-exchanged glass ceramic article to a depth greater than or equal to 2 μm and less than or equal to 3 μm from a first major surface of the first ion-exchanged glass ceramic article to form a post-IOX polished glass ceramic article.

According to embodiments, methods of treating glass ceramic articles may comprise contacting at least a portion of a glass ceramic article with a first salt bath for a first time period greater than or equal to 95 minutes and less than or equal to 115 minutes at a first temperature greater than or equal to 470° C. and less than or equal to 500° C. to form a first ion-exchanged glass ceramic article. The first salt bath may comprise greater than or equal to 80 wt. % and less than or equal to 85 wt. % KNO₃, greater than or equal to 15 wt. % and less than or equal to 20 wt. % NaNO₃, greater than or equal to 0.1 wt. % and less than or equal to 0.3 wt. % LiNO₃, and greater than or equal to 0.2 wt. % and less than or equal to 1 wt. % silicic acid. The method may further comprise contacting the first ion-exchanged glass ceramic article with a second salt bath for a second time period greater than or equal to 10 minutes and less than or equal to 20 minutes and at a second temperature greater than or equal to 470° C. and less than or equal to 500° C. to form a second ion-exchanged glass ceramic article. The second salt bath may comprise greater than or equal to 95 wt. % and less than or equal to 100 wt. % KNO₃, and greater than or equal to 0.2 wt. % and less than or equal to 1 wt. % silicic acid. The method may further comprise removing a portion of the second ion-exchanged glass ceramic article to a depth greater than or equal to 2 μm and less than or equal to 3 μm from a first major surface of the second ion-exchanged glass ceramic article to form a post-IOX polished glass ceramic article.

According to embodiments, post-IOX polished glass ceramic articles may comprise a first major surface and a second major surface opposite the first major surface. The first major surface of the post-IOX polished glass ceramic article may be at least partially coated with a hydrophobic contaminant. The first major surface of the post-IOX polished glass ceramic article may be substantially free from light scattering features after exposing the post-IOX polished glass ceramic article to a temperature of 85° C. at a relative humidity of 85% for a time of 72 hours or longer, wherein the presence of light scattering features is evaluated by an image analysis of a portion of the first major surface of the post-IOX polished glass ceramic article.

According to embodiments, coated glass ceramic articles may comprise a glass ceramic substrate comprising a first major surface and a second major surface opposite the first major surface and a coating covering at least a portion of the first major surface of the glass ceramic substrate. The coating comprises a material having substantially the same index of refraction as the glass ceramic substrate. An outer surface of the coating may be at least partially coated with a hydrophobic contaminant and the outer surface of the coating may be substantially free from light scattering features after exposing the coated glass ceramic article to a temperature of 85° C. at a relative humidity of 85% for a time of 72 hours, wherein the presence of light scattering features is evaluated by an image analysis of a portion of the outer surface of the coating.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions described herein, the concentrations of constituent components (e.g., SiO₂, Al₂O₃, and the like) are specified in mole percent (mol %) on an oxide basis, unless otherwise specified.

The term “substantially free,” when used to describe the concentration and/or absence of a particular constituent component in a glass ceramic composition, means that the constituent component is not intentionally added to the glass ceramic composition. However, the glass ceramic composition may contain traces of the constituent component as a contaminant or tramp in amounts of less than 0.1 mol %.

The terms “0 mol %” and “free,” when used to describe the concentration and/or absence of a particular constituent component in a glass composition, means that the constituent component is not present in glass composition.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. The values reported for surface compressive stress (CS) herein refer to the peak surface compressive stress, unless otherwise indicated. The maximum central tension (CT) values are measured using a SCALP technique known in the art. The values reported for central tension (CT) herein refer to the maximum central tension, unless otherwise indicated.

According to the convention normally used in the art, compression or compressive stress (CS) is expressed as a negative (i.e., <0) stress and tension or tensile stress is expressed as a positive (i.e., >0) stress. Throughout this description, however, CS is expressed as a positive or absolute value (i.e., as recited herein, CS=|CS|).

As used herein, “depth of compression” (DOC) refers to the depth at which the stress within the multi-phase glass changes from compressive to tensile. At the DOC, the stress crosses from a compressive stress to a tensile stress and thus exhibits a stress value of zero. Depth of compression may be measured using a Scattered Light Polariscope (SCALP), such as a SCALP-05 portable scattered light polariscope.

As used herein, the terms “polish” refers to the removal of material from a surface of a glass ceramic article before an ion exchange process, and the terms “post-ion exchange polish” and “post-IOX polish” refer to the removal of material from a surface of a glass ceramic article after an ion exchange process (an ion exchanged glass ceramic article).

As mentioned herein, during the lifecycle of a consumer electronic device, light scattering features may form on the surface of conventional glass ceramic articles, due to the migration of alkali species to the surface of the glass ceramic article. The alkali species that migrate to the surface of the glass ceramic article may form alkali hydroxides. The alkali hydroxides, which are hydrophilic, may separate in the presence of a hydrophobic surface contaminant (e.g., siloxanes from adhesives), thereby forming light scattering features or surface blemishes on the surface that may scatter light and reduce the fidelity of images displayed or captured through the glass ceramic article.

Disclosed herein are methods of treating glass ceramic articles and treated glass ceramic articles that mitigate the aforementioned problems. Specifically, glass ceramic articles may be subjected to at least one of an ion-exchange process followed by a post-IOX polishing process and a coating process.

The ion-exchange process may include contacting the glass ceramic article with a salt bath comprising greater than or equal to 20 wt. % and less than or equal to 90 wt. % KNO₃, greater than or equal to 10 wt. % and less than or equal to 80 wt. % NaNO₃, greater than or equal to 0.03 wt. % and less than or equal to 0.3 wt. % LiNO₃. The amount of lithium and sodium in the salt bath used during the ion-exchange process may reduce the amount of alkali species that can migrate to the surface of the glass ceramic article to form light scattering features. The post-IOX polishing process may include the removal greater than or equal to 2 μm and less than or equal to 10 μm of material from the ion-exchanged surface of the glass ceramic article. The post-IOX polishing process may remove vitrified material from the surface of the ion-exchanged glass ceramic article, which may reduce the amount of alkali species that can migrate to the surface to form light scattering features.

Regarding the coating process, a coated glass ceramic article may comprise a glass ceramic substrate and a coating covering at least a portion of a first major surface of the glass ceramic substrate. The coating may have an index of refraction substantially similar to the index of refraction of the glass ceramic substrate (e.g. SiO₂). Alkali species from the glass ceramic substrate will not migrate through the coating and will not contact a hydrophobic surface contaminant on an outer surface of the coating. This will prevent the formation of light scattering features on the outer surface of the coated glass ceramic article.

In embodiments, glass ceramic articles may be ion-exchanged. In typical ion-exchange processes, smaller metal ions in the glass ceramic articles are replaced or “exchanged” with larger metal ions of the same valence within a layer that is close to the outer surface of the glass ceramic article. The replacement of smaller ions with larger ions creates a compressive stress within the layer of the glass ceramic article. In embodiments, the metal ions are monovalent metal ions (e.g., Li⁺, Na⁺, K⁺, and the like), and ion-exchange is accomplished by immersing the glass ceramic article in a bath comprising at least one molten salt of the larger metal ion that is to replace the smaller metal ion in the glass ceramic article. The ion-exchange process or processes that are used to strengthen the glass ceramic articles may include, but are not limited to, immersion in a single bath or multiple baths of like or different compositions with washing and/or annealing steps between immersions.

Embodiments of the methods for treating glass ceramic articles described herein include contacting at least a portion of a glass ceramic article with a first salt bath to form an ion-exchanged glass ceramic article.

In one or more embodiments, the first salt bath may comprise greater than or equal to 20 wt. % and less than or equal to 90 wt. % KNO₃. For example, without limitation, the first salt bath may comprise KNO₃ in an amount greater than or equal to 20 wt. % and less than or equal to 90 wt. %, greater than or equal to 30 wt. % and less than or equal to 90 wt. %, greater than or equal to 40 wt. % and less than or equal to 90 wt. %, greater than or equal to 50 wt. % and less than or equal to 90 wt. %, greater than or equal to 70 wt. % and less than or equal to 90 wt. %, greater than or equal to 70 wt. % and less than or equal to 90 wt. %, greater than or equal to 80 wt. % and less than or equal to 90 wt. %, greater than or equal to 20 wt. % and less than or equal to 80 wt. %, greater than or equal to 20 wt. % and less than or equal to 70 wt. %, greater than or equal to 20 wt. % and less than or equal to 60 wt. %, greater than or equal to 20 wt. % and less than or equal to 50 wt. %, greater than or equal to 20 wt. % and less than or equal to 40 wt. %, greater than or equal to 20 wt. % and less than or equal to 30 wt. %, or any range or combination of ranges formed from these endpoints. In some embodiments, the first salt bath may comprise greater than or equal to 70 wt. % and less than or equal to 85 wt. %, or greater than or equal to 80 wt. % and less than or equal to 85 wt. % KNO₃.

According to embodiments, the first salt bath may comprise greater than or equal to greater than or equal to 10 wt. % and less than or equal to 80 wt. % NaNO₃. For example, without limitation, the first salt bath may comprise NaNO₃ in an amount greater than or equal to 10 wt. % and less than or equal to 80 wt. %, greater than or equal to 20 wt. % and less than or equal to 80 wt. %, greater than or equal to 30 wt. % and less than or equal to 80 wt. %, greater than or equal to 40 wt. % and less than or equal to 80 wt. %, greater than or equal to 50 wt. % and less than or equal to 80 wt. %, greater than or equal to 60 wt. % and less than or equal to 80 wt. %, greater than or equal to 70 wt. % and less than or equal to 80 wt. %, greater than or equal to 10 wt. % and less than or equal to 70 wt. %, greater than or equal to 10 wt. % and less than or equal to 60 wt. %, greater than or equal to 10 wt. % and less than or equal to 50 wt. %, greater than or equal to 10 wt. % and less than or equal to 40 wt. %, greater than or equal to 10 wt. % and less than or equal to 30 wt. %, greater than or equal to 10 wt. % and less than or equal to 20 wt. %, or any range or combination of ranges formed from these endpoints. In some embodiments, the first salt bath may comprise greater than or equal to greater than or equal to 15 wt. % and less than or equal to 20 wt. % NaNO₃ or greater than or equal to greater than or equal to 15 wt. % and less than or equal to 15 wt. % NaNO₃.

In one or more embodiments, the first salt bath may comprise greater than or equal to 0.1 wt. % and less than or equal to 0.3 wt. % LiNO₃. For example, without limitation, the first salt bath may comprise LiNO₃ in an amount greater than or equal to 0.1 wt. % and less than or equal to 0.3 wt. %, greater than or equal to 0.15 wt. % and less than or equal to 0.3 wt. %, greater than or equal to 0.2 wt. % and less than or equal to 0.3 wt. %, greater than or equal to 0.25 wt. % and less than or equal to 0.3 wt. %, greater than or equal to 0.1 wt. % and less than or equal to 0.25 wt. %, greater than or equal to 0.1 wt. % and less than or equal to 0.2 wt. %, greater than or equal to 0.1 wt. % and less than or equal to 0.15 wt. %, or any range or combination of ranges formed from these endpoints.

In embodiments, the first salt bath may comprise greater than or equal to 0.2 wt. % and less than or equal to 1 wt. % silicic acid. For example, the first salt bath may comprise silicic acid in an amount greater than or equal to 0.2 wt. % and less than or equal to 1 wt. %, greater than or equal to 0.3 wt. % and less than or equal to 1 wt. %, greater than or equal to 0.4 wt. % and less than or equal to 1 wt. %, greater than or equal to 0.5 wt. % and less than or equal to 1 wt. %, greater than or equal to 0.6 wt. % and less than or equal to 1 wt. %, greater than or equal to 0.7 wt. % and less than or equal to 1 wt. %, greater than or equal to 0.8 wt. % and less than or equal to 1 wt. %, greater than or equal to 0.9 wt. % and less than or equal to 1 wt. %, greater than or equal to 0.2 wt. % and less than or equal to 0.9 wt. %, greater than or equal to 0.2 wt. % and less than or equal to 0.8 wt. %, greater than or equal to 0.2 wt. % and less than or equal to 0.7 wt. %, greater than or equal to 0.2 wt. % and less than or equal to 0.6 wt. %, greater than or equal to 0.2 wt. % and less than or equal to 0.5 wt. %, greater than or equal to 0.2 wt. % and less than or equal to 0.4 wt. %, greater than or equal to 0.2 wt. % and less than or equal to 0.3 wt. %, or any range or combination of ranges formed from these endpoints. In some embodiments, the first salt bath may comprise about 0.5 wt. % silicic acid.

In some embodiments, the first salt bath may comprise trisodium phosphate (TSP). In some embodiments, the first salt bath may comprise greater than or equal to 0.03 wt. % and less than or equal to 0.2 wt. % TSP. For example, the first salt bath may comprise TSP in an amount greater than or equal to 0.03 wt. % and less than or equal to 0.2 wt. %, greater than or equal to 0.05 wt. % and less than or equal to 0.2 wt. %, greater than or equal to 0.1 wt. % and less than or equal to 0.2 wt. %, greater than or equal to 0.15 wt. % and less than or equal to 0.2 wt. %, greater than or equal to 0.03 wt. % and less than or equal to 0.15 wt. %, greater than or equal to 0.03 wt. % and less than or equal to 0.1 wt. %, greater than or equal to 0.03 wt. % and less than or equal to 0.05 wt. %, or any range or combination of ranges formed from these endpoints.

In some embodiments, the first salt bath may comprise greater than or equal to 2 wt. % and less than or equal to 30 wt. % of a sulfate salt. In embodiments, the sulfate salt may comprise K₂SO₄, Na₂SO₄, or both. For example, the first salt bath may comprise a sulfate salt in an amount greater than or equal to 2 wt. % and less than or equal to 30 wt. %, greater than or equal to 5 wt. % and less than or equal to 30 wt. %, greater than or equal to 10 wt. % and less than or equal to 30 wt. %, greater than or equal to 15 wt. % and less than or equal to 30 wt. %, greater than or equal to 20 wt. % and less than or equal to 30 wt. %, greater than or equal to 25 wt. % and less than or equal to 30 wt. %, greater than or equal to 2 wt. % and less than or equal to 25 wt. %, greater than or equal to 2 wt. % and less than or equal to 20 wt. %, greater than or equal to 2 wt. % and less than or equal to 15 wt. %, greater than or equal to 2 wt. % and less than or equal to 10 wt. %, greater than or equal to 2 wt. % and less than or equal to 5 wt. %, or any range or combination of ranges formed from these endpoints.

In glass ceramic materials, there are generally two types of alkali metal ions, exchangeable ions in the residue glass and non-exchangeable ions in the crystalline phase of the glass ceramic article. Without intending to be bound by theory, increasing the amount of exchangeable ions may result in an increase in alkali ions that may migrate to the surface of the glass ceramic article and form light scattering features. During ion-exchange processes, when the weight ratio of lithium to sodium is low (i.e., less than 0.0015) non-exchangeable alkali ions may be converted to exchangeable alkali ions through alteration or vitrification of the crystal phase.

In one or more embodiments, the first salt bath may have a weight ratio of lithium to sodium greater than or equal to 3.8×10⁻⁴ and less than or equal to 7.5×10⁻³. For example, the first salt bath may have a weight ratio of lithium to sodium greater than or equal to 3.8×10⁻⁴ and less than or equal to 7.5×10⁻³, greater than or equal to 4.5×10⁻⁴ and less than or equal to 7.5×10⁻³, greater than or equal to 6.5×10⁻⁴ and less than or equal to 7.5×10⁻³, greater than or equal to 8.5×10⁻⁴ and less than or equal to 7.5×10⁻³, greater than or equal to 0.5×10⁻³ and less than or equal to 7.5×10⁻³, greater than or equal to 2.5×10⁻³ and less than or equal to 7.5×10⁻³, greater than or equal to 4.5×10⁻³ and less than or equal to 7.5×10⁻³, greater than or equal to 6.5×10⁻³ and less than or equal to 7.5×10⁻³, greater than or equal to 3.8×10⁻⁴ and less than or equal to 5.5×10⁻³, greater than or equal to 3.8×10⁻⁴ and less than or equal to 3.5×10⁻³, greater than or equal to 3.8×10⁻⁴ and less than or equal to 1.5×10⁻³, greater than or equal to 3.8×10⁻⁴ and less than or equal to 9.5×10⁻⁴, greater than or equal to 3.8×10⁻⁴ and less than or equal to 7.5×10⁻⁴, greater than or equal to 3.8×10⁻⁴ and less than or equal to 5.5×10⁻⁴, or any range or combination of ranges formed from these endpoints.

In embodiments, contacting the glass ceramic article with the first salt bath may occur for a first time period greater than or equal to 7 minutes and less than or equal to 210 minutes. For example, contacting the glass ceramic article with the first salt bath may occur for a first time period greater than or equal to 7 minutes and less than or equal to 210 minutes, greater than or equal to 15 minutes and less than or equal to 210 minutes, greater than or equal to 30 minutes and less than or equal to 210 minutes, greater than or equal to 60 minutes and less than or equal to 210 minutes, greater than or equal to 90 minutes and less than or equal to 210 minutes, greater than or equal to 120 minutes and less than or equal to 210 minutes, greater than or equal to 150 minutes and less than or equal to 210 minutes, greater than or equal to 180 minutes and less than or equal to 210 minutes, greater than or equal to 7 minutes and less than or equal to 180 minutes, greater than or equal to 7 minutes and less than or equal to 150 minutes, greater than or equal to 7 minutes and less than or equal to 120 minutes, greater than or equal to 7 minutes and less than or equal to 90 minutes, greater than or equal to 7 minutes and less than or equal to 60 minutes, greater than or equal to 7 minutes and less than or equal to 30 minutes, greater than or equal to 7 minutes and less than or equal to 15 minutes, or any range or combination of ranges formed from these endpoints. In some embodiments, contacting the glass ceramic article with the first salt bath may occur for a first time period greater than or equal to 90 minutes and less than or equal to 165 minutes.

According to embodiments, contacting the glass ceramic article with the first salt bath may occur at a first temperature greater than or equal to 450° C. and less than or equal to 550° C. For example, contacting the glass ceramic article with the first salt bath may occur at a first temperature greater than or equal to 450° C. and less than or equal to 550° C., greater than or equal to 460° C. and less than or equal to 550° C., greater than or equal to 470° C. and less than or equal to 550° C., greater than or equal to 480° C. and less than or equal to 550° C., greater than or equal to 490° C. and less than or equal to 550° C., greater than or equal to 500° C. and less than or equal to 550° C., greater than or equal to 510° C. and less than or equal to 550° C., greater than or equal to 520° C. and less than or equal to 550° C., greater than or equal to 530° C. and less than or equal to 550° C., greater than or equal to 540° C. and less than or equal to 550° C., greater than or equal to 450° C. and less than or equal to 540° C., greater than or equal to 450° C. and less than or equal to 530° C., greater than or equal to 450° C. and less than or equal to 520° C., greater than or equal to 450° C. and less than or equal to 510° C., greater than or equal to 450° C. and less than or equal to 500° C., greater than or equal to 450° C. and less than or equal to 490° C., greater than or equal to 450° C. and less than or equal to 480° C., greater than or equal to 450° C. and less than or equal to 470° C., greater than or equal to 450° C. and less than or equal to 460° C., or any range or combination of ranges formed from these endpoints.

In one or more embodiments, the glass ceramic article may be contacted with a second salt bath, after contacting the glass ceramic article with the first salt bath, to form the ion-exchanged glass ceramic article.

The second salt bath may comprise greater than or equal to 95 wt. % and less than or equal to 100 wt. % KNO₃. For example, the second salt bath may comprise KNO₃ in an amount greater than or equal to 95 wt. % and less than or equal to 100 wt. %, greater than or equal to 96 wt. % and less than or equal to 100 wt. %, greater than or equal to 97 wt. % and less than or equal to 100 wt. %, greater than or equal to 98 wt. % and less than or equal to 100 wt. %, greater than or equal to 99 wt. % and less than or equal to 100 wt. %, greater than or equal to 95 wt. % and less than or equal to 99 wt. %, greater than or equal to 95 wt. % and less than or equal to 98 wt. %, greater than or equal to 95 wt. % and less than or equal to 97 wt. %, greater than or equal to 95 wt. % and less than or equal to 96 wt. %, or any range or combination of ranges formed from these endpoints.

The second salt bath may comprise greater than or equal to 0 wt. % and less than or equal to 5 wt. % NaNO₃. For example, the second salt bath may comprise NaNO₃ in an amount greater than or equal to 0 wt. % and less than or equal to 5 wt. %, greater than or equal to 1 wt. % and less than or equal to 5 wt. %, greater than or equal to 2 wt. % and less than or equal to 5 wt. %, greater than or equal to 3 wt. % and less than or equal to 5 wt. %, greater than or equal to 4 wt. % and less than or equal to 5 wt. %, greater than or equal to 0 wt. % and less than or equal to 4 wt. %, greater than or equal to 0 wt. % and less than or equal to 3 wt. %, greater than or equal to 0 wt. % and less than or equal to 2 wt. %, greater than or equal to 0 wt. % and less than or equal to 1 wt. %, or any range or combination of ranges formed from these endpoints.

In embodiments, the second salt bath may comprise greater than or equal to 0.2 wt. % and less than or equal to 1 wt. % silicic acid. For example, the second salt bath may comprise silicic acid in an amount greater than or equal to 0.2 wt. % and less than or equal to 1 wt. %, greater than or equal to 0.3 wt. % and less than or equal to 1 wt. %, greater than or equal to 0.4 wt. % and less than or equal to 1 wt. %, greater than or equal to 0.5 wt. % and less than or equal to 1 wt. %, greater than or equal to 0.6 wt. % and less than or equal to 1 wt. %, greater than or equal to 0.7 wt. % and less than or equal to 1 wt. %, greater than or equal to 0.8 wt. % and less than or equal to 1 wt. %, greater than or equal to 0.9 wt. % and less than or equal to 1 wt. %, greater than or equal to 0.2 wt. % and less than or equal to 0.9 wt. %, greater than or equal to 0.2 wt. % and less than or equal to 0.8 wt. %, greater than or equal to 0.2 wt. % and less than or equal to 0.7 wt. %, greater than or equal to 0.2 wt. % and less than or equal to 0.6 wt. %, greater than or equal to 0.2 wt. % and less than or equal to 0.5 wt. %, greater than or equal to 0.2 wt. % and less than or equal to 0.4 wt. %, greater than or equal to 0.2 wt. % and less than or equal to 0.3 wt. %, or any range or combination of ranges formed from these endpoints. In some embodiments, the second salt bath may comprise about 0.5 wt. % silicic acid.

In one or more embodiments, contacting the glass ceramic article with the second salt bath may occur for a second time period greater than or equal to 10 minutes and less than or equal to 30 minutes. For example, contacting the glass ceramic article with the second salt bath may occur for a second time period greater than or equal to 10 minutes and less than or equal to 30 minutes, greater than or equal to 15 minutes and less than or equal to 30 minutes, greater than or equal to 20 minutes and less than or equal to 30 minutes, greater than or equal to 25 minutes and less than or equal to 30 minutes, greater than or equal to 10 minutes and less than or equal to 25 minutes, greater than or equal to 10 minutes and less than or equal to 20 minutes, greater than or equal to 10 minutes and less than or equal to 15 minutes, or any range or combination of ranges formed from these endpoints.

According to some embodiments, contacting the glass ceramic article with the second salt bath may occur at a second temperature greater than or equal to 470° C. and less than or equal to 500° C. For example, contacting the glass ceramic article with the second salt bath may occur at a second temperature greater than or equal to 450° C. and less than or equal to 550° C. For example, contacting the glass ceramic article with the second salt bath may occur at a second temperature greater than or equal to 450° C. and less than or equal to 550° C., greater than or equal to 460° C. and less than or equal to 550° C., greater than or equal to 470° C. and less than or equal to 550° C., greater than or equal to 480° C. and less than or equal to 550° C., greater than or equal to 490° C. and less than or equal to 550° C., greater than or equal to 500° C. and less than or equal to 550° C., greater than or equal to 510° C. and less than or equal to 550° C., greater than or equal to 520° C. and less than or equal to 550° C., greater than or equal to 530° C. and less than or equal to 550° C., greater than or equal to 540° C. and less than or equal to 550° C., greater than or equal to 450° C. and less than or equal to 540° C., greater than or equal to 450° C. and less than or equal to 530° C., greater than or equal to 450° C. and less than or equal to 520° C., greater than or equal to 450° C. and less than or equal to 510° C., greater than or equal to 450° C. and less than or equal to 500° C., greater than or equal to 450° C. and less than or equal to 490° C., greater than or equal to 450° C. and less than or equal to 480° C., greater than or equal to 450° C. and less than or equal to 470° C., greater than or equal to 450° C. and less than or equal to 460° C., or any range or combination of ranges formed from these endpoints.

Embodiments of ion-exchanged glass ceramic articles described herein may comprise a first major surface. In one or more embodiments, the ion-exchanged glass ceramic article may comprise a first major surface and a second major surface opposite the first major surface. In such embodiments, a thickness of the ion-exchanged glass ceramic article is the average distance from the first major surface to the second major surface. According to embodiments, methods of treating glass ceramic articles comprise removing a portion of the ion-exchanged glass ceramic article from a surface of the ion-exchanged glass ceramic article.

As previously described, and without intending to be bound by theory, increasing the amount of exchangeable ions in a glass ceramic article may result in an increase in alkali ions that may migrate to the surface of the glass ceramic article and form light scattering features. During ion-exchange processes, non-exchangeable alkali ions may be converted to exchangeable alkali ions through alteration or vitrification of the crystal phase. This alteration or vitrification may generally occur toward the surface of the glass ceramic article, where ion-exchange takes place. Removing altered or vitrified material from the surface of the ion-exchanged glass ceramic article may reduce the amount of exchangeable alkali ions that may migrate to the surface to form light scattering features.

Methods for treating glass ceramic articles described herein include a post-IOX polishing step comprising removing a portion of the ion-exchanged glass ceramic article to a depth of greater than or equal to 1 μm and less than or equal to 10 μm from a first major surface of the ion-exchanged glass ceramic article to form a post-IOX polished glass article. For example, the method may comprise removing a portion of the ion-exchanged glass ceramic article from a first major surface of the ion-exchanged glass ceramic article to a depth of greater than or equal to 1 μm and less than or equal to 10 μm, greater than or equal to 2 μm and less than or equal to 10 μm, greater than or equal to 4 μm and less than or equal to 10 μm, greater than or equal to 6 μm and less than or equal to 10 μm, greater than or equal to 8 μm and less than or equal to 10 μm, greater than or equal to 1 μm and less than or equal to 9 μm, greater than or equal to 1 μm and less than or equal to 7 μm, greater than or equal to 1 μm and less than or equal to 5 μm, greater than or equal to 1 μm and less than or equal to 3 μm, or any range or combination of ranges formed from these endpoints.

In one or more embodiments, the method may comprise removing a portion of the ion-exchanged glass ceramic article to a depth of greater than or equal to 1 μm and less than or equal to 10 μm from the second major surface of the ion-exchanged glass ceramic article to form a post-IOX polished glass article. For example, the method may comprise removing a portion of the ion-exchanged glass ceramic article from the second major surface of the ion-exchanged glass ceramic article to a depth of greater than or equal to 1 μm and less than or equal to 10 μm, greater than or equal to 2 μm and less than or equal to 10 μm, greater than or equal to 4 μm and less than or equal to 10 μm, greater than or equal to 6 μm and less than or equal to 10 μm, greater than or equal to 8 μm and less than or equal to 10 μm, greater than or equal to 1 μm and less than or equal to 9 μm, greater than or equal to 1 μm and less than or equal to 7 μm, greater than or equal to 1 μm and less than or equal to 5 μm, greater than or equal to 1 μm and less than or equal to 3 μm, or any range or combination of ranges formed from these endpoints. In some embodiments, a portion of the ion-exchanged glass ceramic article may be removed from both the first and second major surfaces.

In one or more embodiments, the portion of the ion-exchanged glass ceramic article may be removed from the first major surface by chemical mechanical polishing. As described herein, chemical mechanical polishing refers to a process of smoothing surfaces with the combination of chemical and mechanical forces. In such processes, an abrasive and corrosive chemical slurry may be used in conjunction with a polishing pad to remove material from the ion-exchanged glass ceramic article.

In one or more embodiments, the portion of the ion-exchanged glass ceramic article may be removed from the first major surface by chemical etching. In such embodiments, the ion-exchanged glass ceramic article may be contacted with an etchant for a duration and at a temperature sufficient to remove the portion of the ion-exchanged glass ceramic article from the first major surface to the desired depth. The ion-exchanged glass ceramic article may be contacted with the etchant by any suitable means. For example, the etchant may be sprayed onto the first major surface of the ion-exchanged glass ceramic article or the ion-exchanged glass ceramic article may be partially for fully immersed in the etchant. In one or more embodiments, the etchant may comprise one or more hydroxides. For example, the etchant may comprise sodium hydroxide, potassium hydroxide, or any other suitable hydroxide. In some embodiments, the etchant may comprise one or more acids. For example, the etchant may comprise hydrofluoric acid.

According to embodiments described herein, post-IOX polished glass ceramic articles may comprise a first major surface. In one or more embodiments, the post-IOX polished glass ceramic article may comprise a first major surface and a second major surface opposite the first major surface. In such embodiments, a thickness of the post-IOX polished glass ceramic article is the average distance from the first major surface to the second major surface.

The post-IOX polished glass ceramic article may comprise potassium at a depth of greater than or equal to 1 μm to less than or equal to 10 μm from the first major surface. For example, the post-IOX polished glass ceramic article may comprise potassium at a depth from the first major surface of greater than or equal to 1 μm to less than or equal to 10 μm, greater than or equal to 2 μm to less than or equal to 10 μm, greater than or equal to 3 μm to less than or equal to 10 μm, greater than or equal to 4 μm to less than or equal to 10 μm, greater than or equal to 5 μm to less than or equal to 10 μm, greater than or equal to 6 μm to less than or equal to 10 μm, greater than or equal to 7 μm to less than or equal to 10 μm, greater than or equal to 8 μm to less than or equal to 10 μm, greater than or equal to 9 μm to less than or equal to 10 μm, greater than or equal to 1 μm to less than or equal to 9 μm, greater than or equal to 1 μm to less than or equal to 8 μm, greater than or equal to 1 μm to less than or equal to 7 μm, greater than or equal to 1 μm to less than or equal to 6 μm, greater than or equal to 1 μm to less than or equal to 5 μm, greater than or equal to 1 μm to less than or equal to 4 μm, greater than or equal to 1 μm to less than or equal to 3 μm, greater than or equal to 1 μm to less than or equal to 2 μm, or any range or combination of ranges formed from these endpoints.

In one or more embodiments, a concentration of potassium at a depth greater than or equal to 0 μm and less than or equal to 10 μm from the first major surface of the post-IOX polished glass ceramic article is greater than or equal to 1 mol % and less than or equal to 1.5 mol %. For example, a concentration of potassium may be greater than or equal to 1 mol % and less than or equal to 1.5 mol % at a depth greater than or equal to 0 μm and less than or equal to 10 μm, greater than or equal to 1 μm and less than or equal to 10 μm, greater than or equal to 2 μm and less than or equal to 10 μm, greater than or equal to 3 μm and less than or equal to 10 μm, greater than or equal to 4 μm and less than or equal to 10 μm, greater than or equal to 5 μm and less than or equal to 10 μm, greater than or equal to 6 μm and less than or equal to 10 μm, greater than or equal to 7 μm and less than or equal to 10 μm, greater than or equal to 8 μm and less than or equal to 10 μm, greater than or equal to 9 μm and less than or equal to 10 μm, greater than or equal to 0 μm and less than or equal to 9 μm, greater than or equal to 0 μm and less than or equal to 8 μm, greater than or equal to 0 μm and less than or equal to 7 μm, greater than or equal to 0 μm and less than or equal to 6 μm, greater than or equal to 0 μm and less than or equal to 5 μm, greater than or equal to 0 μm and less than or equal to 4 μm, greater than or equal to 0 μm and less than or equal to 3 μm, greater than or equal to 0 μm and less than or equal to 2 μm, greater than or equal to 0 μm and less than or equal to 1 μm, or any range or combination of ranges formed from these endpoints. In one or more embodiments, a concentration of potassium, at a depth greater than or equal to 0 μm and less than or equal to 10 μm, may be greater than or equal to 1 mol % and less than or equal to 1.5 mol %, greater than or equal to 1.1 mol % and less than or equal to 1.5 mol %, greater than or equal to 1.2 mol % and less than or equal to 1.5 mol %, greater than or equal to 1.3 mol % and less than or equal to 1.5 mol %, greater than or equal to 1.4 mol % and less than or equal to 1.5 mol %, greater than or equal to 1 mol % and less than or equal to 1.4 mol %, greater than or equal to 1 mol % and less than or equal to 1.3 mol %, greater than or equal to 1 mol % and less than or equal to 1.2 mol %, greater than or equal to 1 mol % and less than or equal to 1.1 mol %, or any range or combination of ranges formed from these endpoints.

Prism coupling is a technique used to couple light into and out of thin film waveguides, enabling the measurement of film thickness and refractive index. It leverages the principle of total internal reflection within the thin film waveguide to excite specific modes of light propagation. By analyzing the angles at which light is coupled into and out of the waveguide, the film's properties may be determined. In one or more embodiments, the post-IOX polished glass ceramic article may have a single guided mode in the prism coupling spectrum at a wavelength between 360 nm and 405 nm for at least one of the transverse-magnetic or transverse-electric polarization, referred to as a 1-fringe spectrum. More specifically, a “1-fringe spectrum” refers to a spectral pattern when a single fringe, a bright or dark band, is present in the output. This fringe arises from interference or diffraction phenomena, creating a localized change in intensity. A 1-fringe spectrum may have advantages for quality control of glass ceramic articles. For example, the 1-fringe spectrum may offer multiple parameters for quality control which allow it to avoid the need for direct tension-zone measurement through scattered-light polarimetry, which is slower and more expensive, and also poorly suited for glasses and glass ceramics having low thickness and/or moderate peak tension, such as 60 MPa or lower. The 1-fringe spectrum may offer a wider measurement window, allowing for accurate compressive stress measurements for a wide range of ion exchange conditions. Without intending to be bound by theory, the ion exchange conditions previously described may result in a potassium concentration in the post-IOX polished glass ceramic article to obtain the 1-fringe spectrum.

In one or more embodiments, a concentration of Li₂O, a concentration of Na₂O, and a concentration of K₂O may be within 5 mol % of each other at a depth greater than or equal to 2 nm and less than or equal to 3 μm from the first major surface of the post-IOX polished glass ceramic article. For example, a concentration of Li₂O, a concentration of Na₂O, and a concentration of K₂O may be within 5 mol %, 4 mol %, 3 mol %, 2 mol %, or even 1 mol % of each other at a depth greater than or equal to 2 nm and less than or equal to 3 μm from the first major surface of the post-IOX polished glass ceramic article.

In some embodiments, the concentration of Li₂O may be greater than the concentration of Na₂O at a depth greater than or equal to 2 nm and less than or equal to 3 μm from the first major surface of the post-IOX polished glass ceramic article. Without intending to be bound by theory, when the concentration of LiO₂ may be greater than the concentration of Na₂O at a depth greater than or equal to 2 nm and less than or equal to 3 μm from first major surface the rate at which non-exchangeable alkali ions are converted to exchangeable alkali ions that may migrate to the surface may be reduced. This may reduce the amount of alkali species that may migrate to the surface to form light scattering features.

The post-IOX polished glass ceramic article may have a compressive stress layer extending from the first major surface to a depth of compression. In one or more embodiments, a depth of compression of the post-IOX polished glass ceramic article may be less than or equal to 120 μm from the first major surface of the post-IOX polished glass ceramic article. For example, the depth of compression of the post-IOX polished glass ceramic article may be less than or equal to 120 μm, 110 μm, 100 μm, 90 μm, 80 μm, 70 μm, 60 μm, 50 μm, 40 μm, 30 μm, 20 μm, or even 10 μm. In one or more embodiments, a compressive stress of the post-IOX polished glass ceramic article may be greater than or equal to 150 MPa and less than or equal to 450 MPa. For example, the compressive stress of the post-IOX polished glass ceramic article may be greater than or equal to 150 MPa and less than or equal to 450 MPa, greater than or equal to 200 MPa and less than or equal to 450 MPa, greater than or equal to 250 MPa and less than or equal to 450 MPa, greater than or equal to 300 MPa and less than or equal to 450 MPa, greater than or equal to 350 MPa and less than or equal to 450 MPa, greater than or equal to 400 MPa and less than or equal to 450 MPa, greater than or equal to 150 MPa and less than or equal to 400 MPa, greater than or equal to 150 MPa and less than or equal to 350 MPa, greater than or equal to 150 MPa and less than or equal to 300 MPa, greater than or equal to 150 MPa and less than or equal to 250 MPa, greater than or equal to 150 MPa and less than or equal to 200 MPa, or any range or combination of ranges formed from these endpoints.

The post-IOX polished glass ceramic article may comprise a region under a tensile stress or central tension. In one or more embodiments, the maximum central tension of the of the post-IOX polished glass ceramic article may be greater than or equal to 35 MPa and less than or equal to 200 MPa. For example, the maximum central tension of the of the post-IOX polished glass ceramic article may be greater than or equal to 35 MPa and less than or equal to 200 MPa, greater than or equal to 50 MPa and less than or equal to 200 MPa, greater than or equal to 75 MPa and less than or equal to 200 MPa, greater than or equal to 100 MPa and less than or equal to 200 MPa, greater than or equal to 125 MPa and less than or equal to 200 MPa, greater than or equal to 150 MPa and less than or equal to 200 MPa, greater than or equal to 175 MPa and less than or equal to 200 MPa, greater than or equal to 35 MPa and less than or equal to 175 MPa, greater than or equal to 35 MPa and less than or equal to 150 MPa, greater than or equal to 35 MPa and less than or equal to 125 MPa, greater than or equal to 35 MPa and less than or equal to 100 MPa, greater than or equal to 35 MPa and less than or equal to 75 MPa, greater than or equal to 35 MPa and less than or equal to 50 MPa, or any range or combination of ranges formed from these endpoints.

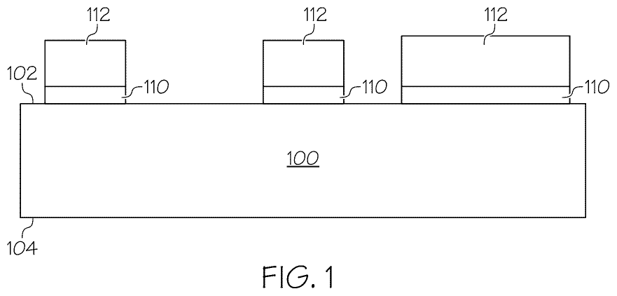

Referring now to FIG. 1, a post-IOX polished glass ceramic article 100 comprises a first major surface 102 and a second major surface 104 opposite the first major surface 102. In one or more embodiments, the first major surface 102 of the post-IOX polished glass ceramic article 100 may be coated with a hydrophobic contaminant 110. The hydrophobic contaminant 110 may comprise polydimethylsiloxane (PDMS). Hydrophobic contaminants 110, such as PDMS, may be included in adhesives that are used to secure the post-IOX polished glass ceramic article 100 to other components 112 of electronic devices, such as displays, sensors, cameras, and transmitters. Hydrophobic contaminants 110 in such adhesives may migrate across the first major surface 102 of the post-IOX polished glass ceramic article 100 once the electronic device is assembled, substantially coating the first major surface 102. It should be noted that the first major surface 102 of the post-IOX polished glass ceramic article 100 may be coated with a hydrophobic contaminant 110 in other manners, including but not limited to applying a hydrophobic contaminant 110 to the first major surface 102 of the post-IOX polished glass ceramic article 100.

In one or more embodiments, the first major surface 102 of the post-IOX polished glass ceramic article 100 may be substantially free from light scattering features after exposing the post-IOX polished glass ceramic article 100 to a temperature greater than or equal to 55° C. and less than or equal to 85° C. at a relative humidity greater than or equal to 85% and less than or equal to 95% for a time from 72 hours. In some embodiments, the first major surface 102 of the post-IOX polished glass ceramic article 100 may be substantially free from light scattering features after exposing the post-IOX polished glass ceramic article 100 to a temperature of 85° C. at a relative humidity of 85% for a time of 72 hours. In some embodiments, the first major surface 192 of the post-IOX polished glass ceramic article 100 may be substantially free from light scattering features after exposing the post-IOX polished glass ceramic article 100 to a temperature of 55° C. at a relative humidity of 95% for a time of 72 hours. In some embodiments, the time may be greater than 72 hours. The first major surface 102 may be evaluated by an image analysis to determine whether light scattering features form on the first major surface 102 of the post-IOX polished glass ceramic article 100. In some embodiments, the image analysis may comprise evaluating the surface with a camera or by eye. The image analysis may also include evaluating the sharpness of an image where the post-IOX polished glass ceramic article is in the optical path between the image and the observer. In some embodiments, the image analysis may include analysis by Time-of-Flight Secondary Ion Mass Spectrometry (ToF-SIMS), analysis of optical micrographs, or both. As described herein, “light scattering features” refer to features on the surface of a glass ceramic article that comprise alkali hydroxides. “Light scattering features,” as used in the present disclosure do not refer to the microstructure of the glass ceramic itself, which may have some light scattering properties.

Without intending to be bound by theory, the ion-exchange process and following post-IOX polishing process described hereinabove may reduce the amount of alkali species that can migrate to the surface of the glass ceramic article to form light scattering features, relative to conventional glass ceramic articles. Light scattering features may form when alkali hydroxides form on the surface of a glass ceramic article in the presence of a hydrophobic surface contaminant. Alkali hydroxides are generally hydrophilic and segregate on the surface to form dot like light scattering features when a hydrophobic surface contaminant is also present at the surface. The light scattering features may comprise alkali hydroxides. When light scattering features form on the surface of a glass ceramic article they may impart a haze to the glass ceramic article. This in turn may reduce the fidelity of image transmission or capture through the glass ceramic article.

According to one or more embodiments described herein, a glass ceramic article may be coated to prevent the formation of light scattering features. In one or more embodiments, a coated glass ceramic article comprises a glass ceramic substrate and a coating covering at least a portion of the glass ceramic substrate.

The glass ceramic substrate may comprise a first major surface and a second major surface opposite the first major surface. A thickness of the glass ceramic substrate is the average distance from the first major surface to the second major surface. In some embodiments, the first major surface and the second major surface of the glass ceramic substrate may be substantially planar.

In embodiments, a root mean square roughness Rq of the first major surface of the glass ceramic substrate is less than or equal to 1 nm. For example, a root mean square roughness Rq of the first major surface of the glass ceramic substrate is less than or equal to 1 nm, 0.9 nm, 0.8 nm, 0.7 nm, 0.6 nm, or even 0.5 nm. Without intending to be bound by theory, if the first major surface of the glass ceramic article is sufficiently smooth (for example, having a roughness Rq less than 1 nm), then the optics of the glass ceramic substrate may not be changed by the coating.

In one or more embodiments, the coating may cover at least a portion of the first major surface of the glass ceramic substrate. In some embodiments, the coating may cover the entirety of the glass ceramic substrate.

The coating may have an inner layer and an outer layer opposite the inner layer. The inner layer of the coating may be in direct contact with the first major surface of the glass ceramic substrate. A thickness of the coating refers to the average distance between the inner layer and the outer layer of the coating. The coating may have a thickness 25% or less of the wavelength of visible light (i.e., a quarter-wave thickness). For example, the minimum wavelength of visible light is about 380 nm, a coating with a thickness of 30 nm is about 8% of the wavelength, and therefore will produce a minimal change in optics (color) for a single-layer coating. In one or more embodiments, the coating may have a thickness greater than or equal to 10 nm and less than or equal to 100 nm. For example, the coating may have a thickness greater than or equal to 10 nm and less than or equal to 100 nm, greater than or equal to 20 nm and less than or equal to 100 nm, greater than or equal to 30 nm and less than or equal to 100 nm, greater than or equal to 40 nm and less than or equal to 100 nm, greater than or equal to 50 nm and less than or equal to 100 nm, greater than or equal to 60 nm and less than or equal to 100 nm, greater than or equal to 70 nm and less than or equal to 100 nm, greater than or equal to 80 nm and less than or equal to 100 nm, greater than or equal to 90 nm and less than or equal to 100 nm, greater than or equal to 10 nm and less than or equal to 90 nm, greater than or equal to 10 nm and less than or equal to 80 nm, greater than or equal to 10 nm and less than or equal to 70 nm, greater than or equal to 10 nm and less than or equal to 60 nm, greater than or equal to 10 nm and less than or equal to 50 nm, greater than or equal to 10 nm and less than or equal to 40 nm, greater than or equal to 10 nm and less than or equal to 30 nm, greater than or equal to 10 nm and less than or equal to 20 nm, or any range or combination of ranges formed from these endpoints. Without intending to be bound by theory, the coating may be sufficiently thick (i.e., having a thickness greater than or equal to 10 nm) to prevent the migration of alkali species through the coating. The coating may act as a diffusion barrier for the alkali species. This may prevent alkali species that migrate to the first major surface of the glass ceramic substrate from contacting a hydrophobic contaminant on the outer surface of the coating, which may prevent the formation of light scattering features.

The coating may comprise one or more layers. For example, the coating may be a single layer coating. In some embodiments, the coating may comprise a plurality of layers. For example, the coating may be a multilayered anti-reflective coating. The coating may be applied to the glass ceramic substrate by any suitable means. For example, the coating may be applied by a sputtering process.

In one or more embodiments, the coating may comprise a material having substantially the same index of refraction as the glass ceramic material. For example, the coating may have an index of refraction within 0.01 of the index of refraction of the glass ceramic material. Without intending to be bound by theory, when the index of refraction of the coating is substantially the same as the index of refraction of the glass ceramic material, the coating may not affect the optical properties of the glass ceramic substrate. In some embodiments, the coating may comprise silicon dioxide. The coating may, in embodiments, consist essentially of or even consist of silicon dioxide.

In one or more embodiments, the outer surface of the coating may be coated with a a hydrophobic contaminant, as previously described. The hydrophobic contaminant may comprise polydimethylsiloxane (PDMS).

In one or more embodiments, the outer surface of the coating is substantially free from light scattering features after exposing the coated glass ceramic article to a temperature greater than or equal to 55° C. and less than or equal to 85° C. at a relative humidity greater than or equal to 85% and less than or equal to 95% for a time from 72 hours. In some embodiments, the outer surface of the coating may be substantially free from light scattering features after exposing the coated glass ceramic article to a temperature of 85° C. at a relative humidity of 85% for a time of 72 hours. In some embodiments, the outer surface of the coating may be substantially free from light scattering features after exposing the coated glass ceramic article to a temperature of 55° C. at a relative humidity of 95% for a time of 72 hours. In some embodiments, the time may be greater than 72 hours. The outer surface of the coating may be evaluated by image analysis to determine whether light scattering features form on the outer surface of the coating of the coated glass ceramic article. In some embodiments, the image analysis may comprise evaluating the surface with a camera or by eye. The image analysis may also include evaluating the sharpness of an image where the coated glass ceramic article is in the optical path between the image and the observer. That is, light scattering features present on the outer surface of the coating may cause the image to appear blurry instead of sharp.

Without intending to be bound by theory, alkali species from the glass ceramic substrate may not migrate through the coating, and may not contact a hydrophobic surface contaminant on an outer surface of the coating. This may prevent the formation of light scattering features on the outer surface of the coated glass ceramic article.

The methods of treating glass ceramic articles and the coated glass ceramic articles described herein may be applied to any suitable glass ceramic. As noted herein, the phrase “glass ceramic” refers to a material or article formed from a precursor glass material following nucleation of at least one crystalline phase in the precursor glass. Thus, a glass ceramic article includes both a glass phase (e.g., amorphous glass; single-phase glass or multi-phase glass) and polycrystalline ceramic (e.g., grains of the primary crystalline phase, optionally with grains of accessory crystalline phase(s)). The glass phase may be referred to as “residual glass” or a “residual glass phase.” In one or more embodiments, the crystalline phase may comprise lithium disilicate, petalite, or both.

SiO₂ may be the primary glass former in the precursor glass and glass ceramic compositions described herein and may function to stabilize the network structure of the glass ceramics. The concentration of SiO₂ in the precursor glass and glass ceramic compositions should be sufficiently high (e.g., greater than or equal to 55 mol %) to form the crystalline phase when the precursor glass is heat-treated to convert the precursor glass to a glass ceramic. The amount of SiO₂ may be limited (e.g., to less than or equal to 75 mol %) to control the melting point of the precursor glass or glass ceramic composition, as the melting temperature of pure SiO₂ or high-SiO₂ glasses is undesirably high. Thus, limiting the concentration of SiO₂ may aid in improving the meltability and the formability of the precursor glass or glass ceramic composition.

Accordingly, in embodiments, the precursor glass or glass ceramic composition may comprise greater than or equal to 55 mol % and less than or equal to 75 mol % SiO₂. For example, the glass ceramic composition may comprise SiO₂ in an amount greater than or equal to 55 mol % and less than or equal to 75 mol %, greater than or equal to 60 mol % and less than or equal to 75 mol % SiO₂, greater than or equal to 65 mol % and less than or equal to 75 mol %, greater than or equal to 70 mol % and less than or equal to 75 mol %, greater than or equal to 55 mol % and less than or equal to 70 mol %, greater than or equal to 55 mol % and less than or equal to 65 mol %, greater than or equal to 55 mol % and less than or equal to 60 mol %, or any range or combination of ranges formed from these endpoints.

Like SiO₂, Al₂O₃ may also stabilize the glass network and additionally provides improved mechanical properties and chemical durability to the glass ceramics. The amount of Al₂O₃ may also be tailored to the control the viscosity of the precursor glass or glass ceramic composition. However, if the amount of Al₂O₃ is too high, the viscosity of the glass melt may increase. In embodiments, the precursor glass or glass ceramic composition may comprise greater than or equal to 0.2 mol % and less than or equal to 10 mol % Al₂O₃. For example, the glass ceramic may comprise Al₂O₃ in an amount greater than or equal to 0.2 mol % and less than or equal to 10 mol %, greater than or equal to 0.5 mol % and less than or equal to 10 mol %, greater than or equal to 1 mol % and less than or equal to 10 mol %, greater than or equal to 3 mol % and less than or equal to 10 mol %, greater than or equal to 5 mol % and less than or equal to 10 mol %, greater than or equal to 7 mol % and less than or equal to 10 mol %, greater than or equal to 9 mol % and less than or equal to 10 mol %, greater than or equal to 0.2 mol % and less than or equal to 8 mol %, greater than or equal to 0.2 mol % and less than or equal to 6 mol %, greater than or equal to 0.2 mol % and less than or equal to 10 mol %, greater than or equal to 0.2 mol % and less than or equal to 4 mol %, greater than or equal to 0.2 mol % and less than or equal to 2 mol %, greater than or equal to 0.2 mol % and less than or equal to 0.5 mol %, or any range or combination of ranges formed from these endpoints.

B₂O₃ decreases the Young's modulus of the glass ceramic, which helps to reduce the central tension and stress intensity of an article formed therefrom. When the boron present is not charge balanced by alkali oxides (such as Na₂O, Li₂O and K₂O) or divalent cation oxides (such as MgO, CaO, SrO, BaO, and ZnO), the boron will be in a trigonal-coordinated state (or three-coordinated boron), which opens up the structure of the glass. The network around these three-coordinated boron atoms is not as rigid as tetrahedrally coordinated (or four-coordinated) boron. Without being bound by theory, it is believed that glass compositions that include three-coordinated boron can tolerate some degree of deformation (e.g., flexing and/or bending) before crack formation compared to four-coordinated boron. By tolerating some deformation, the Vickers indentation crack initiation threshold values increase. Fracture toughness of the glass compositions that include three-coordinated boron may also increase. B₂O₃ may also decrease the melting temperature of the glass composition. The amount of boron should be limited to less than 5 mol % in order to maintain chemical durability and mechanical strength.

In embodiments, the precursor glass or glass ceramic composition may comprise greater than or equal to 0 mol % and less than or equal to 5 mol % B₂O₃. For example, the glass ceramic may comprise B₂O₃ in an amount greater than or equal to 0 mol % and less than or equal to 5 mol %, greater than or equal to 1 mol % and less than or equal to 5 mol %, greater than or equal to 2 mol % and less than or equal to 5 mol %, greater than or equal to 3 mol % and less than or equal to 5 mol %, greater than or equal to 4 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0 mol % and less than or equal to 1 mol %, or any range or combination of ranges formed from these endpoints.

Li₂O may aid in forming lithium disilicate crystal phases in the glass ceramic. In embodiments, the precursor glass or glass ceramic composition may comprise greater than or equal to 15 mol % and less than or equal to 30 mol % Li₂O. For example, the glass ceramic may comprise Li₂O in an amount greater than or equal to 15 mol % and less than or equal to 30 mol %, greater than or equal to 20 mol % and less than or equal to 30 mol %, greater than or equal to 25 mol % and less than or equal to 30 mol %, greater than or equal to 15 mol % and less than or equal to 25 mol %, greater than or equal to 15 mol % and less than or equal to 20 mol %, or any range or combination of ranges formed from these endpoints.

The glass ceramic compositions may contain alkali oxides, such as Na₂O, to enable the ion-exchangeability of the glass compositions. Na₂O aids in the ion-exchangeability of the glass composition and also reduces the softening point of the glass composition thereby increasing the formability of the glass. In embodiments, the precursor glass or glass ceramic composition may comprise greater than or equal to 0 mol % and less than or equal to 2 mol % Na₂O. For example, the glass ceramic may comprise Na₂O in an amount greater than or equal to 0 mol % and less than or equal to 2 mol %, greater than or equal to 0.1 mol % and less than or equal to 2 mol %, greater than or equal to 0.5 mol % and less than or equal to 2 mol %, greater than or equal to 1 mol % and less than or equal to 2 mol %, greater than or equal to 1.5 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, or any range or combination of ranges formed from these endpoints.

K₂O, when included, promotes ion-exchange and may increase the depth of compression and decrease the melting point to improve the formability of the glass ceramic. However, adding too much K₂O may cause the surface compressive stress and melting point to be too low. Accordingly, in embodiments, the amount of K₂O added to the glass ceramic may be limited. In embodiments, the precursor glass or glass ceramic composition may comprise greater than or equal to 0 mol % and less than or equal to 2 mol % K₂O. For example, the glass ceramic may comprise K₂O in an amount greater than or equal to 0 mol % and less than or equal to 2 mol %, greater than or equal to 0.1 mol % and less than or equal to 2 mol %, greater than or equal to 0.5 mol % and less than or equal to 2 mol %, greater than or equal to 1 mol % and less than or equal to 2 mol %, greater than or equal to 1.5 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, or any range or combination of ranges formed from these endpoints.

In embodiments, the precursor glass or glass ceramic composition may comprise greater than or equal to 0 mol % and less than or equal to 2 mol % MgO. For example, the glass ceramic may comprise MgO in an amount greater than or equal to 0 mol % and less than or equal to 2 mol %, greater than or equal to 0.1 mol % and less than or equal to 2 mol %, greater than or equal to 0.5 mol % and less than or equal to 2 mol %, greater than or equal to 1 mol % and less than or equal to 2 mol %, greater than or equal to 1.5 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, or any range or combination of ranges formed from these endpoints.

In embodiments, the precursor glass or glass ceramic composition may comprise greater than or equal to 0 mol % and less than or equal to 2 mol % ZnO. For example, the glass ceramic may comprise ZnO in an amount greater than or equal to 0 mol % and less than or equal to 2 mol %, greater than or equal to 0.1 mol % and less than or equal to 2 mol %, greater than or equal to 0.5 mol % and less than or equal to 2 mol %, greater than or equal to 1 mol % and less than or equal to 2 mol %, greater than or equal to 1.5 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, or any range or combination of ranges formed from these endpoints.

The glass ceramics described herein may further comprise P₂O₅. P₂O₅ may decrease the Young's modulus of the glass ceramic, which helps to reduce the central tension and stress intensity of an article formed therefrom. P₂O₅ may also lower the melting and liquidus temperatures and may increase inter-ionic diffusivity such that the time required for ion-exchange is reduced. In embodiments, the precursor glass or glass ceramic composition may comprise greater than or equal to 0.2 mol % and less than or equal to 3 mol % P₂O₅. For example, the glass ceramic may comprise P₂O₅ in an amount greater than or equal to 0.2 mol % and less than or equal to 3 mol %, greater than or equal to 0.5 mol % and less than or equal to 3 mol %, greater than or equal to 1 mol % and less than or equal to 3 mol %, greater than or equal to 1.5 mol % and less than or equal to 3 mol %, greater than or equal to 2 mol % and less than or equal to 3 mol %, greater than or equal to 2.5 mol % and less than or equal to 3 mol %, greater than or equal to 0.2 mol % and less than or equal to 2.5 mol %, greater than or equal to 0.2 mol % and less than or equal to 2 mol %, greater than or equal to 0.2 mol % and less than or equal to 1.5 mol %, greater than or equal to 0.2 mol % and less than or equal to 1 mol %, greater than or equal to 0.2 mol % and less than or equal to 0.5 mol %, or any range or combination of ranges formed from these endpoints.

ZrO₂ can improve the stability of the glass ceramic by reducing glass devitrification during forming and decreasing the liquidus temperature. In embodiments, the precursor glass or glass ceramic composition may comprise greater than or equal to 0.1 mol % and less than or equal to 10 mol % ZrO₂. For example, the glass ceramic may comprise ZrO₂ in an amount greater than or equal to 0.1 mol % and less than or equal to 10 mol %, greater than or equal to 0.5 mol % and less than or equal to 10 mol %, greater than or equal to 1 mol % and less than or equal to 10 mol %, greater than or equal to 3 mol % and less than or equal to 10 mol %, greater than or equal to 5 mol % and less than or equal to 10 mol %, greater than or equal to 7 mol % and less than or equal to 10 mol %, greater than or equal to 9 mol % and less than or equal to 10 mol %, greater than or equal to 0.1 mol % and less than or equal to 8 mol %, greater than or equal to 0.1 mol % and less than or equal to 6 mol %, greater than or equal to 0.1 mol % and less than or equal to 4 mol %, greater than or equal to 0.1 mol % and less than or equal to 2 mol %, or any range or combination of ranges formed from these endpoints.

In embodiments, the precursor glass or glass ceramic composition may comprise greater than or equal to 0 mol % and less than or equal to 4 mol % TiO₂. For example, the glass ceramic may comprise TiO₂ in an amount greater than or equal to 0 mol % and less than or equal to 4 mol %, greater than or equal to 1 mol % and less than or equal to 4 mol %, greater than or equal to 2 mol % and less than or equal to 4 mol %, greater than or equal to 3 mol % and less than or equal to 4 mol %, greater than or equal to 0 mol % and less than or equal to 3 mol %, greater than or equal to 0 mol % and less than or equal to 2 mol %, greater than or equal to 0 mol % and less than or equal to 1 mol %, or any range or combination of ranges formed from these endpoints.

In embodiments, the precursor glass or glass ceramic composition may comprise greater than or equal to 0 mol % and less than or equal to 1 mol % SnO₂. For example, the glass ceramic may comprise SnO₂ in an amount greater than or equal to 0 mol % and less than or equal to 1 mol %, greater than or equal to 0.2 mol % and less than or equal to 1 mol %, greater than or equal to 0.4 mol % and less than or equal to 1 mol %, greater than or equal to 0.6 mol % and less than or equal to 1 mol %, greater than or equal to 0.8 mol % and less than or equal to 1 mol %, greater than or equal to 0 mol % and less than or equal to 0.9 mol %, greater than or equal to 0 mol % and less than or equal to 0.7 mol %, greater than or equal to 0 mol % and less than or equal to 0.5 mol %, greater than or equal to 0 mol % and less than or equal to 0.3 mol %, greater than or equal to 0 mol % and less than or equal to 0.1 mol %, or any range or combination of ranges formed from these endpoints.

In embodiments, the precursor glass or glass ceramic composition may comprise greater than or equal to 0 mol % and less than or equal to 2 mol % Y₂O₃. For example, the glass ceramic may comprise Y₂O₃ in an amount greater than or equal to 0 mol % and less than or equal to 2 mol %, greater than or equal to 0.1 mol % and less than or equal to 2 mol %, greater than or equal to 0.5 mol % and less than or equal to 2 mol %, greater than or equal to 1 mol % and less than or equal to 2 mol %, greater than or equal to 1.5 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, or any range or combination of ranges formed from these endpoints.

As a result of the raw materials and/or equipment used to produce the glass or glass ceramic composition of various embodiments, certain impurities or components that are not intentionally added may be present in the final glass or glass ceramic composition. Such materials are present in the glass or glass ceramic composition in minor amounts and are referred to herein as “tramp materials.” As used herein, “tramp materials” may be present in an amount of less than 1000 ppm. In some embodiments, the glass or glass ceramic composition may further include tramp materials, for example MnO, Nb₂O₅, MoO₃, Ta₂O₅, WO₃, La₂O₃, HfO₂, CdO, As₂O₃, Sb₂O₃, sulfur-based compounds, for example sulfates, halogens, or combinations thereof. In some embodiments, antimicrobial components, chemical fining agents, or other additional components may be included in the glass or glass ceramic composition.

In some embodiments, the glasses and/or glass ceramics described herein can be manufactured into sheets via processes, including, but not limited to, fusion forming, slot draw, float, rolling, and other sheet-forming processes known to those in the art. The glass ceramic articles and glass ceramic substrates described hereinabove may be formed form such sheets.

The glass ceramic articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a glass-ceramic article as described herein.

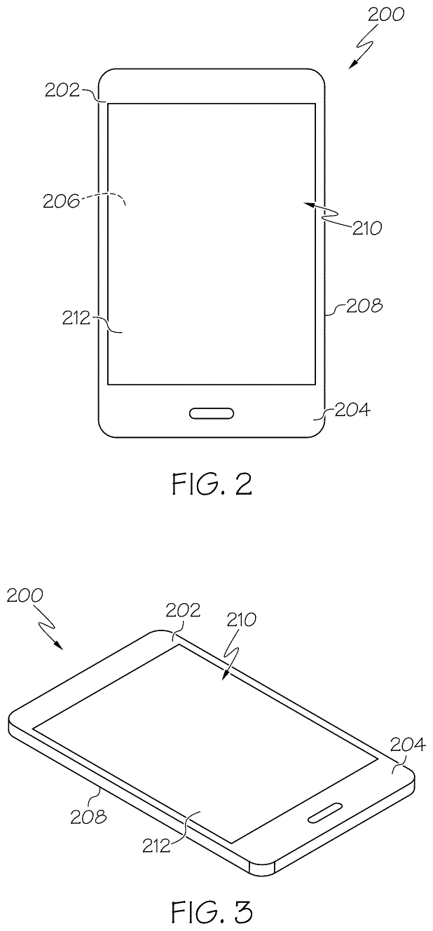

An exemplary electronic device incorporating any of the glass ceramic articles disclosed herein is shown in FIGS. 2 and 3. Specifically, FIGS. 2 and 3 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass ceramic articles disclosed herein.

### EXAMPLES

The embodiments described herein will be further clarified by the following examples.

### Ion-Exchange and Post-IOX Polishing of Glass Ceramic Articles

Glass ceramic articles were subjected to ion-exchange (IOX) processes. The glass ceramic articles were lithium disilicate/petalite glass ceramics. The glass ceramics had the composition given in Table 1.

TABLE 1
Glass Ceramic Composition

| Oxide | Mol % |
|---|---|
| SiO₂ | 70.39 |
| Al₂O₃ | 4.21 |
| P₂O₅ | 0.85 |
| Li₂O | 21.16 |
| Na₂O | 1.50 |
| K₂O | 0.13 |
| ZrO₂ | 1.71 |
| CaO | 0.01 |
| Fe₂O₃ | 0.02 |
| HfO₂ | 0.02 |
| SnO₂ | 0.01 |

The ion-exchange conditions (IOX Conditions) for the glass ceramic articles are included below in Table 2. In IOX Conditions 1-3, trisodium phosphate (TSP) was added to the salt bath to simulate manufacturing conditions. In the conditions where TSP was included in the salt bath, the concentration of lithium in the salt bath was not affected. IOX Conditions 8 and 9 were two step ion-exchange processes, where the glass ceramic article was subjected to a first ion-exchange treatment followed by a second ion-exchange treatment. In Table 2, the conditions of the first ion-exchange treatment are given above the conditions of the second ion-exchange treatment for each of IOX Conditions 8 and 9. IOX Conditions 1, 2, and 5 had relatively high LiNO₃ concentrations in the salt bath relative to IOX Condition 3. IOX Conditions 4, 8, and 9, had relatively high KNO₃ concentrations in the salt baths relative to IOX Condition 3.

TABLE 2

| | | | | Silicic | | | | | Loading |
|---|---|---|---|---|---|---|---|---|---|
| IOX | KNO₃ | NaNO₃ | LiNO₃ | acid | TSP | K₂SO₄ | Temp. | Time | density |
| Condition | (wt %) | (wt %) | (wt %) | (wt %) | (wt %) | (wt %) | (° C.) | (min) | (m²/kg) |
| 1 | 70 | 30 | 0.12 | 0.5 | 0.03 | — | 500 | 90 | 0.025 |
| 2 | 65 | 30 | 0.12 | 0.5 | 0.03 | 5 | 500 | 90 | 0.025 |
| 3 | 70 | 30 | 0.04 | 0.5 | 0.2 | — | 500 | 90 | 0.025 |
| 4 | 100 | — | — | 0.5 | — | — | 500 | 90 | 0.025 |
| 5 | 80 | 20 | 0.1 | 0.5 | — | — | 500 | 130 | 0.025 |
| 6 | 83 | 17 | 0.03 | 0.5 | — | — | 500 | 165 | 0.025 |
| 7 | 85 | 15 | 0.05 | 0.5 | — | — | 500 | 125 | 0.025 |
| 8 | 85 | 15 | 0.1 | 0.5 | — | — | 500 | 105 | 0.025 |
| | 100 | — | — | 0.5 | — | — | 500 | 15 | 0.025 |
| 9 | 80 | 20 | 0.1 | 0.5 | — | — | 500 | 105 | 0.025 |
| | 100 | — | — | 0.5 | — | — | 500 | 15 | 0.025 |

The concentration of LiNO₃ in the salt bath before and after the ion-exchange processes at IOX Conditions 1-4 are given in Table 3. As shown in Table 3, the amount of LiNO₃ in the salt bath increased during the ion-exchange process at each of IOX Conditions 1-4. An increase in the concentration of LiNO₃ in the salt bath or an increase in the ratio of Li to Na atoms in the salt bath may help to prevent the dissolution of the lithium containing crystals near the surface of the glass ceramic article. When the lithium containing crystals are dissolved or amorphize, they may become easier to leach out during the ageing process.

TABLE 3

| IOX | Pre-IOX LiNO₃ | Post-IOX LiNO₃ |
|---|---|---|
| Condition | (wt %) | (wt %) |
| 1 | 0.1125 | 0.1597 |
| 2 | 0.1059 | 0.1623 |
| 3 | 0.0128 | 0.0356 |
| 4 | 0.0000 | 0.0082 |

After the ion-exchange processes, ion-exchanged glass ceramic articles subjected to IOX Conditions 1, 2, 3, 4, 8, and 9 were post-IOX polished to remove about 2 μm of material from the surface of the ion-exchanged glass ceramic articles. The compressive stress (CS) of each of the ion-exchanged glass ceramic articles (not post-IOX polished) I1, I2, I3, I4, I5, and I6, and the post-IOX polished, ion-exchanged glass ceramic articles P1, P2, P3, P4, P5, and P6 subjected to the various IOX Conditions as shown in Table 4, was measured by FSM. The compressive stresses are given in Table 4. As shown in Table 4, post-IOX polishing the ion-exchanged glass ceramic articles reduced the compressive stress of the glass ceramic articles relative to the ion-exchanged glass ceramic articles that were not post-IOX polished.

TABLE 4

| Ion-exchanged glass | IOX | | |
|---|---|---|---|
| ceramic article | Condition | Post-IOX Polishing | CS (MPa) |
| I1 | 1 | Not Post-IOX Polished | 164.26 |
| P1 | | Post-IOX Polished | 149.32 |
| I2 | 2 | Not Post-IOX Polished | 171.72 |
| P2 | | Post-IOX Polished | 150.26 |
| I3 | 3 | Not Post-IOX Polished | 221.19 |
| P3 | | Post-IOX Polished | 205.32 |
| I4 | 4 | Not Post-IOX Polished | 411.82 |
| P4 | | Post-IOX Polished | 165.96 |
| I5 | 8 | Not Post-IOX Polished | 424 |
| P5 | | Post-IOX Polished | 116 |
| I6 | 9 | Not Post-IOX Polished | 424 |
| P6 | | Post-IOX Polished | 116 |

### Ageing of Ion-Exchanged Glass Ceramic Articles

The ion-exchanged glass ceramic articles and the post-IOX polished, ion-exchanged glass ceramic articles were subjected to an ageing process to analyze the formation of light scattering features on the surface of the articles. The glass ceramic articles were washed with Alconox detergent. Then, glass ceramic articles were contaminated with polydimethylsiloxane (PDMS) by placing about 20 μL of silicone oil on a lens tissue and wiping it across one surface of the glass ceramic article. Excess silicone oil was removed by wiping the surface of the glass ceramic article with a fresh lens tissue until no streaking was observed in an oblique reflection. The glass ceramic articles were loaded into a Teflon and stainless steel fixture and inserted into a chamber. The fixture was tented with UHV foil to prevent contaminants from the chamber from contacting the surfaces of the glass ceramic articles. The chamber was heated to a temperature of 85° C. at a relative humidity of 85% for a time of 72 hours.

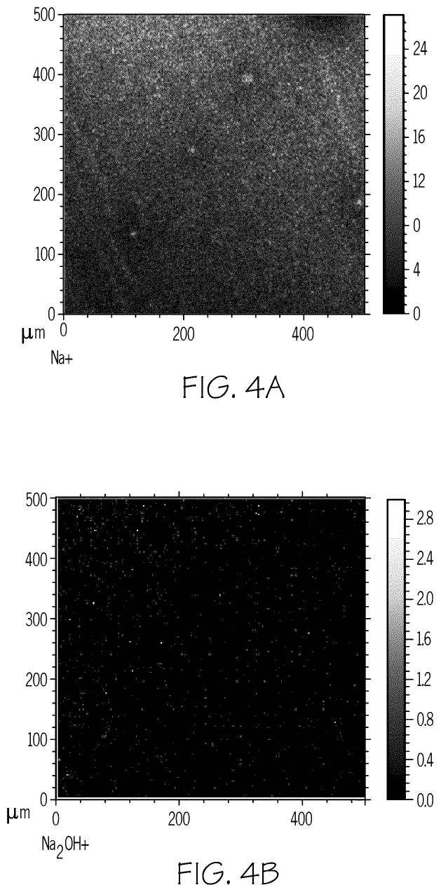

After the heat treatment, the glass ceramic articles were analyzed by Time-of-Flight Secondary Ion Mass Spectrometry (ToF-SIMS). FIG. 4A depicts the ion signal from Na⁺ on the surface of the post-IOX polished glass ceramic article P6 that was contaminated with PDMS, and FIG. 4B depicts the ion signal from Na₂OH⁺ on the surface of the post-IOX polished glass ceramic article P6 that was contaminated with PDMS. As shown in FIG. 4B, no NaOH formed on the surface of the glass ceramic article after contamination and ageing. Accordingly, light scattering features did not form on the surface of the glass ceramic article.

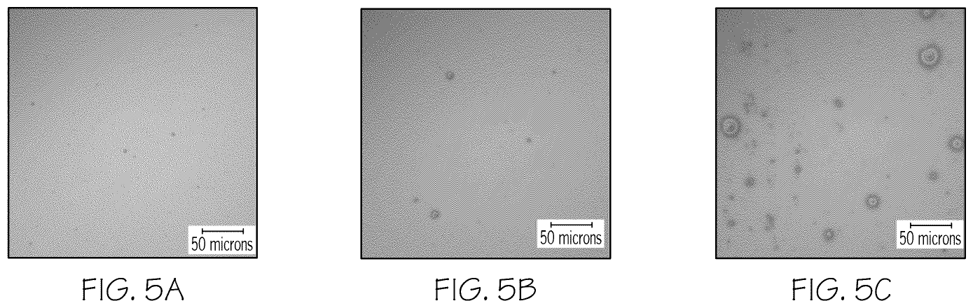

Optical micrographs of aged glass ceramic articles are depicted in FIGS. 5A-5C. FIG. 5A is an optical micrograph of the post-IOX polished glass ceramic article P1 after ageing. FIG. 5B is an optical micrograph of the post-IOX polished glass ceramic article P3 after ageing. FIG. 5C is an optical micrograph of the post-IOX polished glass ceramic article I3 after ageing. The glass ceramic article P1 depicted in FIG. 5A showed the best performance after the ageing process by having the fewest light scattering features. The glass ceramic article P3 depicted in FIG. 5B had some light scattering features after ageing, and the glass ceramic article I3 depicted in FIG. 5C had more light scattering features after ageing. Ion-exchanging glass ceramic articles according to the methods described herein minimizes the formation of light scattering features.

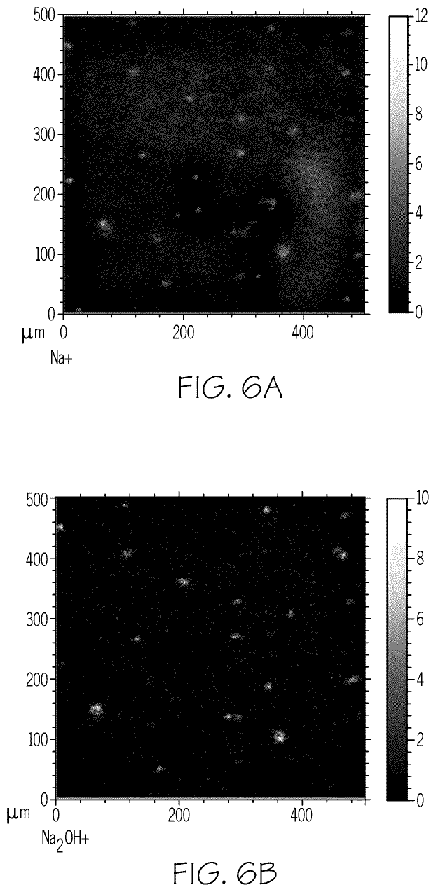

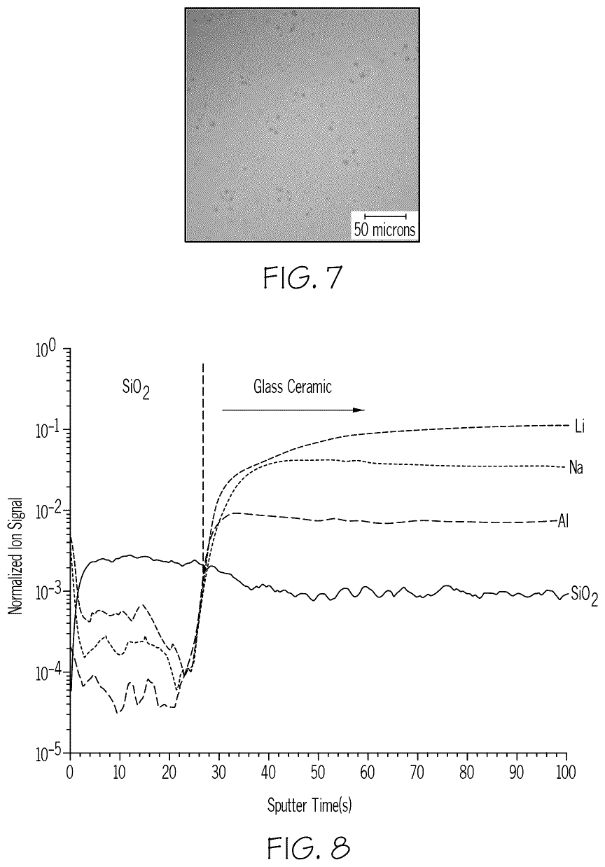

A comparative glass ceramic article having the composition given in Table 4 was subjected to the ageing process described above. ToF-SIMS images of the aged comparative glass ceramic are depicted in FIGS. 6A and 6B. FIG. 6A depicts the concentration of Na⁺ on the surface of the aged comparative glass ceramic. FIG. 6B depicts the concentration of Na₂OH⁺ on the surface of the aged comparative glass ceramic. As shown in FIGS. 6A and 6B NaOH deposits were formed at the surface of the aged comparative glass ceramic that was coated with PDMS. FIG. 7 is an optical micrograph of the aged comparative glass ceramic. As shown in FIG. 7, the NaOH deposits are visible light scattering features on the surface of the aged comparative glass ceramic that impart a light scattering effect to the aged comparative glass ceramic.

TABLE 4
Comparative Glass Ceramic

| Oxide | Mol % |
|---|---|
| SiO₂ | 70.20 |
| Al₂O₃ | 4.39 |
| B₂O₃ | 0.001 |
| P₂O₅ | 0.83 |
| CaO | 0.01 |
| Li₂O | 21.06 |
| Na₂O | 0.51 |
| K₂O | 0.15 |
| ZrO₂ | 2.74 |
| HfO₂ | 0.03 |
| Sb₂O₃ | 0.08 |

### Coating Glass Ceramic Articles

The surface of a glass ceramic article having the composition given in Table 1 was coated with a single layer of SiO₂. The coating was 30 nm thick. The coating was applied by sputter PVD. FIG. 8 depicts the depth profile. The depth profile was obtained by time-of-flight secondary ion mass spectrometry. A 2 keV Cs⁺ beam was used to sputter a crater of 300 μm×300 μm. The measured ions were generated with a 30 keV Bi₃⁺ liquid metal ion gun rastered over a 50 μm×50 μm analysis area.

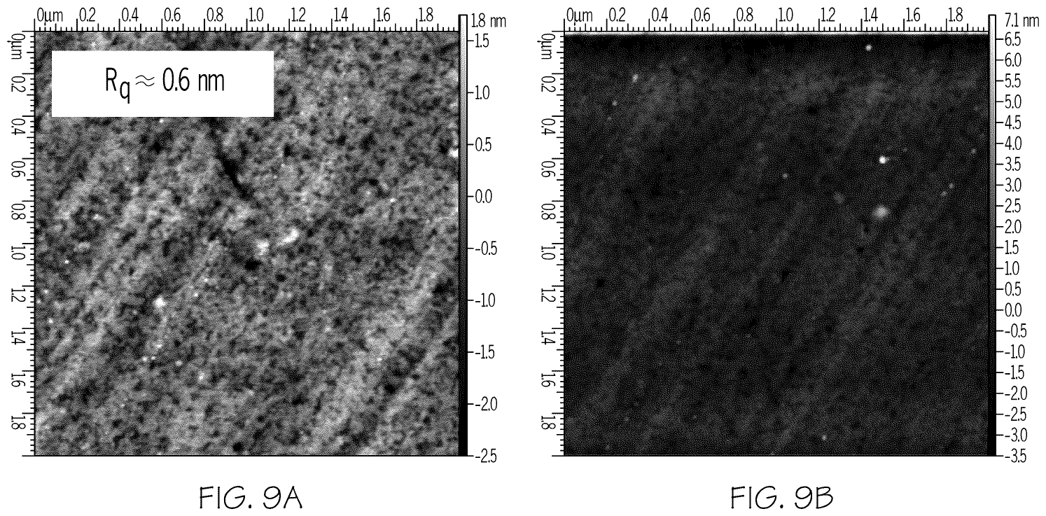

The root mean square (RMS) roughness of the surface of the glass ceramic article was 0.6 nm before coating. FIGS. 9A and 9B show atomic force microscopy (AFM) images of two regions of the surface of the glass ceramic article prior to coating. The RMS roughness is small enough so as not to have a measurable influence on the optics of any applied coating. If the RMS roughness is large (e.g. approaching λ/4 for visible light) it can act as a thin low-index layer and affect the optics of a coated glass ceramic part.

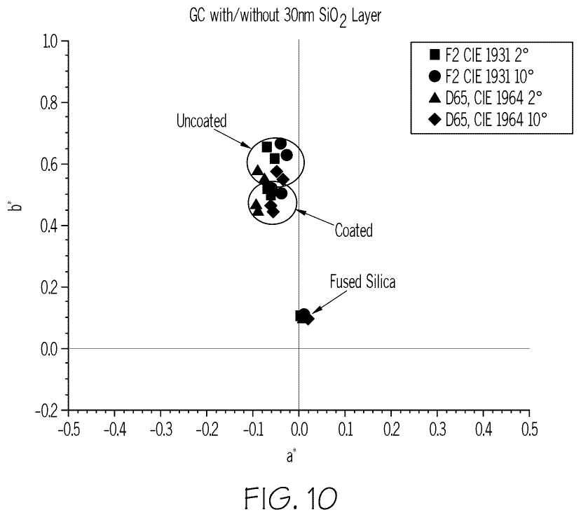

Color data was measured for the glass ceramic article before coating and after coating. The results are depicted in FIG. 10. Color measurements were made on a PerkinElmer Lambda 1050+−1 Spectrophotometer with a 150 mm integrating sphere. The operating parameters were: 2400 nm to 200 nm, data interval: 2 nm, detector changeover (InGaAs to PMT): 860.8 nm. Source: Tungsten-halogen. Source Change: 319.2 nm InGaAs gain: 15 InGaAs averaging time: 0.52 sec PMT spectral band width: 3 nm PMT averaging time: 0.2 sec Beam mode: Double. The coated glass ceramic is slightly more color neutral, being less yellow than the uncoated parts. The fused silica data is plotted as a reference point on the graph.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method of treating a glass ceramic article, the method comprising,
contacting at least a portion of the glass ceramic article with a first salt bath to form an ion-exchanged glass ceramic article, wherein the first salt bath comprises:
greater than or equal to 20 wt. % and less than or equal to 90 wt. % KNO₃;
greater than or equal to 10 wt. % and less than or equal to 80 wt. % NaNO₃;
greater than or equal to 0.03 wt. % and less than or equal to 0.3 wt. % LiNO₃; and
greater than or equal to 0.2 wt. % and less than or equal to 1 wt. % silicic acid; and
removing a portion of the ion-exchanged glass ceramic article to a depth greater than or equal to 1 μm and less than or equal to 10 μm from a first major surface of the ion-exchanged glass ceramic article to form a post-IOX polished glass ceramic article.

2. The method of claim 1, wherein the contacting the at least a portion of the glass ceramic article with the first salt bath occurs for a first time period greater than or equal to 7 minutes and less than or equal to 210 minutes.

3. The method of claim 1, wherein the contacting the at least a portion of the glass ceramic article with the first salt bath occurs at a first temperature greater than or equal to 450° C. and less than or equal to 550° C.

4. The method of claim 1, further comprising removing a portion of the ion-exchanged glass ceramic article to a depth greater than or equal to 1 μm and less than or equal to 10 μm from a second major surface of the ion-exchanged glass ceramic article.

5. The method of claim 1, wherein a weight ratio of lithium to sodium in the first salt bath is greater than or equal to 3.8×10⁻⁴ and less than or equal to 7.5×10⁻³.

6. The method of claim 1, further comprising contacting the glass ceramic article with a second salt bath, after contacting the glass ceramic article with the first salt bath, to form the ion-exchanged glass ceramic article, wherein the second salt bath comprises:
greater than or equal to 95 wt. % and less than or equal to 100 wt. % KNO₃;
greater than or equal to 0 wt. % and less than or equal to 5 wt. % NaNO₃; and
greater than 0.2 wt. % and less than or equal to 1 wt. % silicic acid.

7. The method of claim 1, wherein the glass ceramic article comprises:
greater than or equal to 55 mol % and less than or equal to 75 mol % SiO₂;
greater than or equal to 0.2 mol % and less than or equal to 10 mol % Al₂O₃;
greater than or equal to 0 mol % and less than or equal to 5 mol % B₂O₃;
greater than or equal to 15 mol % and less than or equal to 30 mol % Li₂O;
greater than or equal to 0 mol % and less than or equal to 2 mol % Na₂O;
greater than or equal to 0 mol % and less than or equal to 2 mol % K₂O;
greater than or equal to 0 mol % and less than or equal to 2 mol % MgO;
greater than or equal to 0 mol % and less than or equal to 2 mol % ZnO;
greater than or equal to 0.2 mol % and less than or equal to 3 mol % P₂O₅;
greater than or equal to 0.1 mol % and less than or equal to 10 mol % ZrO₂;
greater than or equal to 0 mol % and less than or equal to 4 mol % TiO₂;
greater than or equal to 0 mol % and less than or equal to 1 mol % SnO₂; and
greater than or equal to 0 mol % and less than or equal to 2 mol % Y₂O₃.

8. The method of claim 1, wherein the post-IOX polished glass ceramic article comprises potassium at a depth of greater than or equal to 1 μm to less than or equal to 10 μm from the first major surface.

9. The method of claim 1, wherein a concentration of potassium at a depth greater than or equal to 1 μm and less than or equal to 10 μm from the first major surface of the post-IOX polished glass ceramic article is greater than or equal to 1 mol % and less than or equal to 1.5 mol %.

10. The method of claim 1, wherein the post-IOX polished glass ceramic article comprises a single guided mode in a prism coupling spectrum at a wavelength between 360 nm and 405 nm for at least one of a transverse-magnetic or transverse-electric polarization.

11. The method of claim 1, wherein a concentration of Li₂O, a concentration of Na₂O, and a concentration of K₂O are within 5 mol % of each other at a depth greater than or equal to 2 nm and less than or equal to 3 μm from the first major surface of the post-IOX polished glass ceramic article.

12. The method of claim 1, wherein a depth of compression of the post-IOX polished glass ceramic article is less than or equal to 120 μm.

13. The method of claim 1, wherein a compressive stress of the post-IOX polished glass ceramic article is greater than or equal to 150 MPa and less than or equal to 450 MPa.

14. The method of claim 1, wherein a maximum central tension of the post-IOX polished glass ceramic article is greater than or equal to 35 MPa and less than or equal to 200 MPa.

15. A post-IOX polished glass ceramic article comprising a first major surface and a second major surface opposite the first major surface, wherein:
the first major surface of the post-IOX polished glass ceramic article is at least partially coated with a hydrophobic contaminant; and
the first major surface of the post-IOX polished glass ceramic article is substantially free from light scattering features after exposing the post-IOX polished glass ceramic article to a temperature greater than or equal to 55° C. and less than or equal to 85° C. at a relative humidity greater than or equal to 85% and less than or equal to 95% for a time of 72 hours, wherein a presence of light scattering features is evaluated by an image analysis of a portion of the first major surface of the post-IOX polished glass ceramic article.

16. The post-IOX polished glass ceramic article of claim 15, wherein the hydrophobic contaminant comprises polydimethylsiloxane (PDMS).

17. The post-IOX polished glass ceramic article of claim 15, wherein the light scattering features comprise one or more alkali hydroxides.

18. The post-IOX polished glass ceramic article of claim 15, wherein a concentration of potassium at a depth greater than or equal to 1 μm and less than or equal to 10 μm from the first major surface of the post-IOX polished glass ceramic article is greater than or equal to 1 mol % and less than or equal to 1.5 mol %.

19. The post-IOX polished glass ceramic article of claim 15, wherein a concentration of Li₂O, a concentration of Na₂O, and a concentration of K₂O are within 5 mol % of each other at a depth greater than or equal to 2 nm and less than or equal to 3 μm from the first major surface of the post-IOX polished glass ceramic article.

20. The post-IOX polished glass ceramic article of claim 15, wherein:
a depth of compression of the post-IOX polished glass ceramic article is less than or equal to 120 μm;
a compressive stress of the post-IOX polished glass ceramic article is greater than or equal to 150 MPa and less than or equal to 450 MPa; and
a maximum central tension of the post-IOX polished glass ceramic article is greater than or equal to 35 MPa and less than or equal to 200 MPa.
